(19) United States
(12) Patent Application Publication
(10) Pub. No.: US 2025/0183978 A1
(43) Pub. Date: Jun. 5, 2025

(54) REFERENCE SIGNAL CONFIGURATIONS FOR MULTIPLEXING USER EQUIPMENT ON SAME SIDELINK RESOURCES

(71) Applicant: QUALCOMM Incorporated, San Diego, CA (US)

(72) Inventors: Ahmed ELSHAFIE, San Diego, CA (US); Wei YANG, San Diego, CA (US); Yu ZHANG, San Diego, CA (US); Hung Dinh LY, San Diego, CA (US); Seyedkianoush HOSSEINI, San Diego, CA (US)

(21) Appl. No.: 18/838,746

(22) PCT Filed: Apr. 11, 2022
(86) PCT No.: PCT/CN2022/086111

§ 371 Date: Aug. 15, 2024

(51) Int. Cl. H04B 7/06; H04B 7/04; H04L 27/26

(52) U.S. Cl. CPC H04B 7/06952; H04B 7/04013; H04L 27/2607

(57) ABSTRACT

Sidelink reference signal (SL-RS) configurations are determined for transmission from multiple transmitting user equipment devices (UE) to one receiving UE. A master wireless communications device is assigned from among the transmitting UEs, the receiving UE, or a base station. The master wireless communications device assigns a sidelink reference signal configuration to each participating UE. The sidelink reference signal configuration may include a designation of resources for the SL-RS, a cyclic shift, a comb offset, a port, or report configurations. By adding a cyclic shift, comb offset, port, or report configuration, SL-RS signals from the transmitting UEs may be multiplexed and transmitted to the receiving UE using the same sidelink resources. Thus, transmitting UEs may be trained to select optimum beams, according to the assigned SL-RS configuration of each, and may transmit a same transport block (TB), a joint TB, or a different TB.

### TECHNICAL FIELD

The present disclosure is directed to wireless communication systems and methods and more particularly to devices, systems, and methods for increasing the efficient use of radio resources for sidelink reference signal transmissions used in training multiple transmitting user equipment.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). With sidelinks, UEs do not need to tunnel through a BS or an associated core network.

Sidelink technology has been extended to provision for device-to-device (D2D) communications, vehicle-to-everything (V2X) communications, and/or cellular vehicle-to-everything (C-V2X) communications over licensed bands and/or unlicensed bands. To facilitate this sidelink transmission, the UEs using the may perform beam training based on one or more sidelink reference signals. However, when multiple transmitting UEs are trained in conjunction with a same receiving UE, inefficiencies related to performing beam training with multiple transmitting UEs can lead to increased transmission times, increased power consumption, and reduced signal quality. For example, current approaches limit the density of sidelink reference signals to one per resource block. Further, devices such as reconfigurable intelligent surfaces (RISs) or amplify and forward (AF) relays may be used to reflect/retransmit signals around obstructions, including in sidelink, such that any beam training must take these additional devices into account as well.

Therefore, there exists a need for improved methods of beam training for multiple transmitting UEs in conjunction with a single receiving UE to coherently communicate with the receiving UE, with and without RISs.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one aspect of the present disclosure, a method of wireless communication, includes: transmitting, by a first wireless communications device, a sidelink reference signal via a sidelink communication to a second wireless communications device, wherein the sidelink reference signal comprises a cyclic shift and is generated based on a parameter configuration for a plurality of transmitter wireless communications devices including the first wireless communications device, the sidelink reference signal further being multiplexed with a plurality of sidelink reference signals from the plurality of transmitter wireless communications devices; receiving, by the first wireless communications device, a beam training report from the second wireless communications device based on the sidelink reference signal; and transmitting, by the first wireless communications device, data to the second wireless communications device using a beam selected based on the beam training report.

According to another aspect of the present disclosure, a method of wireless communication, includes: receiving, by a first wireless communications device, a plurality of sidelink reference signals via a sidelink communication from a plurality of transmitter wireless communications devices, wherein the plurality of sidelink reference signals are multiplexed, comprise a cyclic shift, and are formed based on parameter configurations for the plurality of transmitter wireless communications devices; transmitting, by the first wireless communications device, a beam training report to the plurality of transmitter wireless communications devices, the beam training report generated based on the plurality of sidelink reference signals; and receiving, by the first wireless communications device, data from the plurality of transmitter wireless communications devices using one or more beams selected based on the beam training report.

According to another aspect of the present disclosure, a wireless communications device includes: a transceiver; and a processor coupled with the transceiver, wherein the wireless communications device is configured to: transmit a sidelink reference signal via a sidelink communication, wherein the sidelink reference signal comprises a cyclic shift and is generated based on a parameter configuration for a plurality of transmitter wireless communications devices including the wireless communications device, the sidelink reference signal further being multiplexed with a plurality of sidelink reference signals from the plurality of transmitter wireless communications devices; receive a beam training report based on the sidelink reference signal; and transmit data using a beam selected based on the beam training report.

According to another aspect of the present disclosure, a wireless communications device, includes: a transceiver, and a processor coupled with the transceiver, wherein the wireless communications device is configured to: receive a plurality of sidelink reference signals via a sidelink communication, wherein the plurality of sidelink reference signals are multiplexed, comprise a cyclic shift, and are formed based on parameter configurations for a plurality of transmitter wireless communications devices; transmit a beam training report, the beam training report based on the plurality of references signals; and receive data using one or more beams selected based on the beam training report.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example of a wireless communication network configured for sidelink communications according to some aspects of the present disclosure.

FIG. 3 is a block diagram of an exemplary UE, according to some aspects of the present disclosure.

FIG. 4 is a block diagram of an exemplary BS, according to some aspects of the present disclosure.

FIG. 5 illustrates a communication scenario involving multiple transmitting UEs and a receiving UE, according to some aspects of the present disclosure.

FIG. 6 illustrates a communication scenario involving multiple transmitting UEs, a receiving UE, and a RIS, according to some aspects of the present disclosure.

FIG. 7 is a block diagram of sidelink reference signals corresponding to transmitting UEs, according to aspects of the present disclosure.

FIG. 8 is a signaling diagram of a beam training method for multiple transmitting UEs and a receiving UE, according to aspects of the present disclosure.

FIG. 9 is a flow diagram of a wireless communication method, according to some aspects of the present disclosure.

FIG. 10 is a flow diagram of a wireless communication method, according to some aspects of the present disclosure.

FIG. 11 is a flow diagram of a wireless communication method according to some aspects of the present disclosure.

FIG. 12 is a diagram illustrating an example disaggregated BS architecture, according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

5G NR supports sidelink transmission of data between one or more UEs. To facilitate sidelink transmission, resources for beam training and data transmission are designated. In mode 1, sidelink resources may be scheduled by a gNB in communication with one or more of the participating UEs. In this scenario, the gNB may assign resources including dynamic allocation via DCI format as well as configured transmissions including both Type-1 and Type-2. In mode 2, sidelink resources may be selected by one of the participating UEs without input from a gNB. The UE selecting sidelink resources may be referred to as the master wireless communications device or master UE. The master UE may select sidelink resources from a pre-configured (e.g., by a serving gNB) sidelink resource pool based on a channel sensing mechanism. For example, the UE may determine available resources and select resources for transmission based on the determination, including based on the priority of different transmissions, or quality of available resources or channels.

A UE may be configured to receive data from multiple transmitting UEs in sidelink. To optimize transmissions between the transmitting UEs and the receiving UE, the devices may perform beam training. During beam training, the transmitting UEs may transmit one or more reference signals (referred to here generally as sidelink reference signals) via multiple training beams to the receiving UE. The receiving UE may analyze the received signals. To do so, the receiving UE may measure signal quality associated with the received signals and determine which received signals correspond to the optimum beam for each transmitting UE or for all the transmitting UEs as a whole. The receiving UE may then prepare one or more beam training reports and transmit these reports to the transmitting UEs. Based on these reports, the transmitting UEs may select the appropriate or recommended beam for transmission and transmit data to the receiving UE based on that selection.

To generally facilitate beam training of multiple transmitting UEs in communication with a receiving UE, aspects of the disclosure introduce cyclic shifts to sidelink transmission, such that each sidelink reference signal further includes a cyclic shift). This allows for multiplexing of UEs in sidelink reference signal transmissions. Aspects of the disclosure further include adding additional comb offsets for sidelink reference signal transmission, increasing the density for sidelink reference signal transmission, and/or allowing the configuration/reconfiguration of sidelink report configuration.

As discussed further herein, the type of beam training that the receiving UE performs, including how the sidelink reference signals and beam training report(s) are configured for all the participating UEs (generally referred to also as reference signal parameter(s)), may be determined based on the type of actual data to be transmitted (referred to herein with respect to the transport block(s) (TB) used for the data transmission). Thus, scenarios where multiple UEs transmit the same TB to the receiving UE may result in a first type of beam training (the type being based on the parameters for the sidelink reference signal and/or the report), while different TBs may result in different types of training. For example, in some instances the transmitting UEs may be assigned to transmit different TBs to the receiving UE, resulting in a second type of beam training. In other instances, the transmitting UEs are assigned to transmit a joint TB to the receiving UE (e.g., each transmitting UE may transmit a different portion of a given TB to the receiving UE), resulting in a third type of beam training. A master UE may be responsible for assigning the reference signal parameters amongst the various UEs, or supervise the determination of those parameters.

For the scenario in which multiple transmitting UEs are assigned to coherently transmit a single TB (the first type of beam training), training of the transmitting UEs may be performed coherently. In such a situation, the master UE may assign a reference signal parameter to each transmitting UE. This reference signal parameter may be different between UEs (e.g., different cyclic shifts for sidelink reference signals transmitting on the same time/frequency resources), or may be the same between the different transmitting UEs (e.g., cyclic shift, comb offset, and/or port parameters). In this scenario, the transmitting UEs may transmit the reference signal in such a way that the receiving UE observes a single signal that is a combination of multiple, or all, of the transmitting UEs' sidelink reference signals.

For the scenario in which multiple transmitting UEs are assigned to transmit different TBs (the second type of beam training), training of the transmitting UEs may be performed non-coherently. In such a situation, the master UE may assign a reference signal parameter to each transmitting UE that allows the receiving UE to determine which signal originated from which transmitting UE. For example, the master UE may assign to each transmitting UE a different cyclic shift, comb offset, and/or port. This enables the receiving UE to determine which signal came from which transmitting device based on the different reference signal parameter of each received sidelink reference signal. The receiving UE, in some examples, may determine whether to perform joint beam training (also referred to as joint sounding) of the different channels or individual sounding. This may be determined solely by the receiving UE, or in cooperation with one or more of the transmitting UEs.

For the scenario in which multiple transmitting UEs are assigned to transmit different portions of a same TB (the third type of beam training noted above), different reference signal parameters may be assigned to each transmitting UE to again allow for differentiation of signals. For example, the master UE may assign to each transmitting UE a different cyclic shift, comb offset, and/or port (may also be referred to as antenna port). This may further include beam sweeping across multiple sidelink reference signals (by the transmitting UEs) and the receiving UE checking if the signals are coherently adding up or not. As with the second type of beam training noted above, the receiving UE may determine whether to perform joint beam training (also referred to as joint sounding) of the different channels or individual sounding. This may be determined solely by the receiving UE, or in cooperation with one or more of the transmitting UEs.

More generally, the configuration of the beam training reports as part of the reference signal parameters may include a first part configured by a gNB (or multiple gNB or other network node(s)), such as on a per-resource-pool basis or common across multiple pools, using RRC and/or MAC-CE signaling. With that part configured, the master UE may configure the other nodes (including UEs and, in some examples, one or more RISs), with the used report configuration. Further, the sidelink reference signal parameters such as cyclic shift may be determined a variety of ways, including by random selection (e.g., by the respective transmitting UEs), or by selection by the master UE based on UE identifying parameters such as an identifier, or by the master UE making a set of possible resources available for selection and the transmitting UEs making a selection of the cyclic shift based on some local identifier.

Aspects of the present disclosure can provide several benefits. For example, by including cyclic shifts, additional comb offsets, and/or increasing density, sidelink reference signals associated with multiple transmitting UEs may be multiplexed onto the same time/frequency resources to one or more receiving UEs. This results in higher data rates in sidelink transmissions, as well as improved capacity and improved spectral efficiency. In addition, by allowing for joint beam training for transmitting UEs assigned to transmit a single TB, different TBs, or a joint TB, efficiency of training of multiple transmitting UEs may be increased. Aspects of the present disclosure may also advantageously reduce noise and/or error associated with transmitting sidelink reference signals or TBs in sidelink. Power consumption and transmission time for sidelink beam training or sidelink communication may also be decreased by reducing the degree of processing for participating UEs.

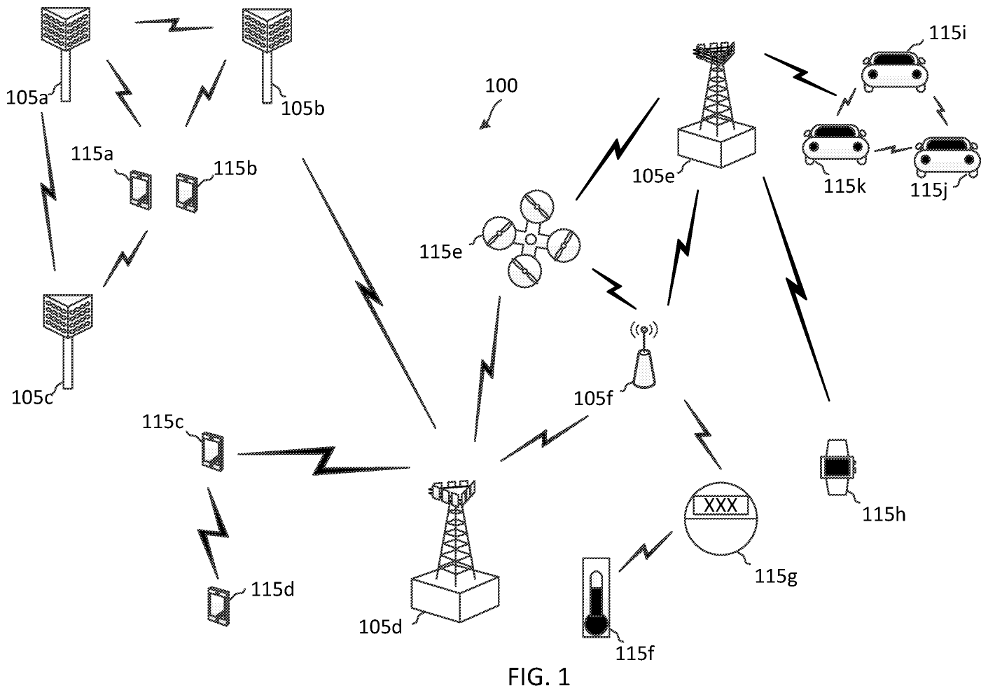

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communications device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communications devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115 (e.g., sidelink communications), and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. As further discussed with respect to the remaining figures below, sidelink UEs 115 may transmit sidelink reference signals between each other, such as for example modeled after CSI-RS, though other types are possible as well.

Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 may initiate an initial network attachment procedure with the network 100. When the UE 115 has no active data communication with the BS 105 after the network attachment, the UE 115 may return to an idle state (e.g., RRC idle mode). Alternatively, the UE 115 and the BS 105 can enter an operational state or active state, where operational data may be exchanged (e.g., RRC connected mode). For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may transmit a PRACH configuration to the UE 115. The PRACH configuration may indicate a set of ROs in the PRACH configuration. The BS 105 and/or the UE 115 may divide ROs into different groups, including a first group of ROs configured for PRACH repetitions, and a second group configured for single PRACH transmissions. In addition to BS-UE communication, as noted briefly above various UEs 115 may additionally, or alternatively, engage in sidelink communications with each other. And, according to embodiments of the present disclosure, the UEs thus engaged in sidelink communications may be configured for multiplexing multiple UEs' sidelink reference signals onto the same resources through the configuration and sharing of one or more sidelink reference signal parameters between the participating UEs, as will be further described with respect to the figures below.

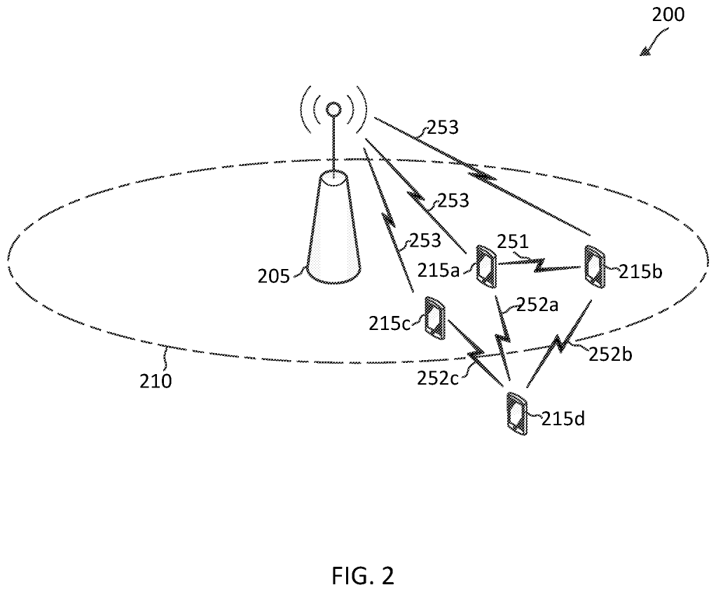

FIG. 2 illustrates an example of a wireless communication network 200 configured for sidelink communications according to embodiments of the present disclosure. The network 200 may be similar to the network 100. FIG. 2 illustrates one BS 205 and four UEs 215 for purposes of simplicity of discussion, though it will be recognized that embodiments of the present disclosure may scale to any suitable number of UEs 215 and/or BSs 205 (e.g., 2, 3, 6, 7, 8, or more). The BS 205 and the UEs 215 may be similar to the BSs 105 and the UEs 115, respectively. The BS 205 and the UEs 215 may communicate over the same spectrum.

In the network 200, some of the UEs 215 may communicate with each other in peer-to-peer communications, also referred to as sidelink communication. Sidelink communications refers to the communications among user equipment devices (UEs) without tunneling through a base station (BS) and/or a core network (e.g., via a PC5 link instead). For example, the UE 215a may communicate with the UE 215b over a sidelink 251, and the UE 215c may communicate with the UE 215d over another sidelink 252c. As further illustrated, UEs 215a and 215b may also communicate with the UE 215d over similar sidelinks 252a and 252b, respectively. In some instances, the sidelinks 251 and (in general) 252 are unicast bidirectional links, each between a pair of UEs 215. In some other instances, the sidelinks 251 and 252 can be multicast links supporting multicast sidelink services among the UEs 215. Multicast sidelink services may include groupcast or broadcast links. In a groupcast link, a transmitting UE 215 has a link with a sub-set of specific UEs 215 in its vicinity. In a broadcast link, a transmitting UE 215 has a link with all UEs 215 within its range. As an example of multicast sidelink services, the UE 215c may transmit multicast data to the UE 215d and the UE 215b over sidelinks.

Some of the UEs 215 may also communicate with the BS 205 in a UL direction and/or a DL direction via communication links 253. For instance, the UE 215a, 215b, and 215c are within a coverage area 210 of the BS 205, and thus may be in communication with the BS 205. The UE 215d is outside the coverage area 210, and thus may not be in direct communication with the BS 205. In some instances, the UE 215c may operate as a relay for the UE 215d to reach the BS 205. In some aspects, some of the UEs 215 are associated with vehicles (e.g., similar to the UEs 115i-k) and the communications over the sidelinks 251 and/or 252 may be C-V2X communications. C-V2X communications may refer to communications between vehicles and any other wireless communications devices in a cellular network.

As used herein, the terms “sidelink transmitting UE” and “transmitting UE” can refer to a user equipment device performing a sidelink transmission operation. As used herein, the terms “sidelink receiving UE” and “receiving UE” can refer to a user equipment device performing a sidelink reception operation. As used herein, the terms “anchor UE” or “sidelink anchor UE” can refer to a sidelink UE designated as an anchor node with a stand-alone sidelink configuration that can initiate sidelink operations autonomously (e.g., independent of any cell and/or associated core network), and the terms are interchangeable without departing from the scope of the present disclosure.

NR supports multiple modes of radio resource allocations (RRA), including a mode-1 RRA and a mode-2 RRA, for sidelink over a licensed spectrum. The mode-1 RRA supports network controlled RRA that can be used for in-coverage sidelink communication. For instance, a serving BS (e.g., gNB) may determine a radio resource on behalf of a sidelink UE and transmit an indication of the radio resource to the sidelink UE. In some aspects, the serving BS grants a sidelink transmission with downlink control information (DCI). For this mode, however, there is significant base station involvement and is typically operable when the sidelink UE is within the coverage area of the serving BS, but not necessarily for out-of-coverage sidelink scenarios. In FIG. 2, the sidelink 251 is an example of mode-1 RRA.

The mode-2 RRA supports autonomous RRA that can be used for out-of-coverage sidelink UEs or partial-coverage sidelink UEs. For instance, an out-of-coverage sidelink UE or a partial-coverage UE may be preconfigured with a sidelink resource pool and may select a radio resource from the preconfigured sidelink resource pool for sidelink communication. For this mode, it may be possible for V2X systems to operate independent of the serving BS. However, the mode-2 RRA relies on the sidelink settings across different environments (e.g., vehicles). For instance, this mode may require the sidelink settings to be uniform so that each sidelink UE (e.g., vehicle) can communicate with one another. This would rely on equipment user vendors (e.g., different automotive manufacturers) to coordinate and implement common sidelink settings. This may pose a substantial burden on the equipment user vendors to develop and implement a uniform sidelink setting so that NR-U sidelink user equipment devices can communicate via respective sidelink connections. As such, there is a desire to deploy the NR-U sidelink system as a stand-alone system. In FIG. 2, the sidelinks 252 are all examples of possible mode-2 RRA (though UEs 215a, 215b, and 215c are all illustrated as in-coverage to the BS 205, this is for simplicity of illustration; all or some of the UEs may alternatively be out-of-coverage, and that may vary as the UEs move about).

In some aspects, the network 200 may be a LTE network. The transmissions by the UE 215a and the UE 215b over the sidelink 251 and/or the transmissions by the UE 215c and the UE 215d over the sidelink 252c (and sidelinks 252a and 252b) may reuse a LTE PUSCH waveform, which is a discrete Fourier transform-spreading (DFT-s) based waveform. In some aspects, the network 200 may be an NR network. The transmissions by the UEs 215 over the sidelinks 251 and/or 252 may use a cyclic-prefix-OFDM (CP-OFDM) waveform. In some aspects, the network 200 may operate over a shared radio frequency band (e.g., an unlicensed band). The transmissions by the UEs 215 over the sidelinks 251 and/or 252 may use a frequency interlaced waveform.

Sidelink communication can be communicated over a physical sidelink control channel (PSCCH) and a physical sidelink shared channel (PSSCH). The PSCCH is analogous to a physical downlink control channel (PDCCH) and the PSSCH to a physical downlink shared channel (PDSCH) in downlink (DL) communication between a BS and a UE. For instance, the PSCCH may carry sidelink control information (SCI) and the PSSCH may carry sidelink data. Each PSCCH is associated with a corresponding PSSCH, where SCI in a PSCCH may carry scheduling information for sidelink data transmission in the associated PSSCH. In some examples, a UE may transmit PSSCH carrying SCI, which may be indicated in multiple stages (e.g., two stages, three stages, and/or the like).

According to aspects of the present disclosure, multiplexing of multiple UEs on sidelink for sidelink reference signals is enabled by adding a cyclic shift to each transmitting UE's sidelink reference signal (e.g., to each UE's CSI-RS being transmitted on sidelink, where that configuration is used). Aspects of the disclosure further include adding additional comb offsets for sidelink reference signal transmission, increasing the density for sidelink reference signal transmission, and/or allowing the configuration/reconfiguration of sidelink report configuration. The type of beam training that the receiving UE performs, including how the sidelink reference signal parameters are configured for all the participating UEs, may be determined based on how TBs are transmitted (e.g., either the same TB transmitted by multiple UEs, or joint TB transmission, or different TB transmission from each UE).

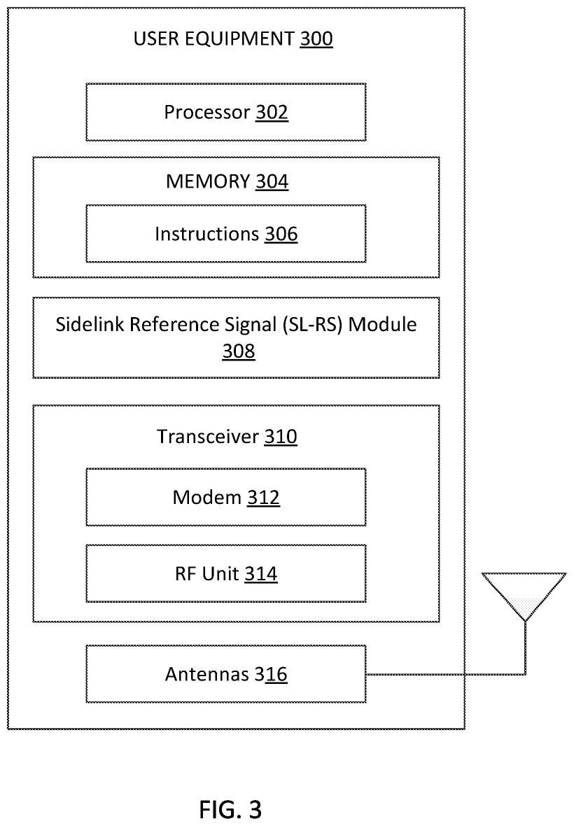

FIG. 3 is a block diagram of an exemplary UE 300 according to some aspects of the present disclosure. The UE 300 may be a UE 115 as discussed with reference to FIG. 1 and shown in multiple figures. As shown, the UE 300 may include a processor 302, a memory 304, a sidelink reference signal (SL-RS) module 308, a transceiver 310 including a modem subsystem 312 and a radio frequency (RF) unit 314, and one or more antennas 316. These elements may be coupled with one another. The term “coupled” may refer to directly or indirectly coupled or connected to one or more intervening elements. For instance, these elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

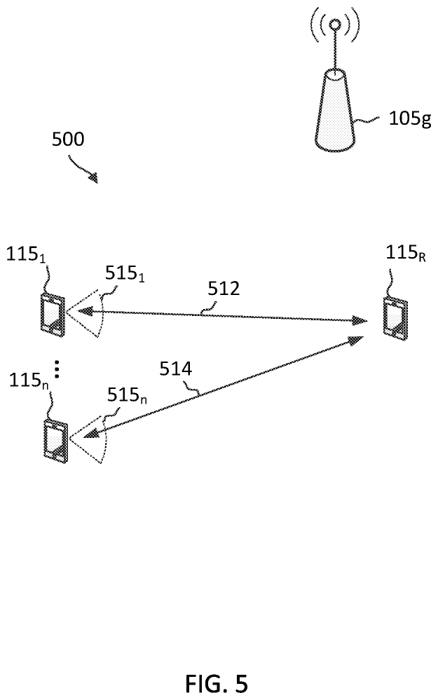

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to a UE 115 or a BS 105 or other wireless communications device in connection with aspects of the present disclosure, for example, aspects of FIGS. 5-12. Instructions 306 may also be referred to as code, which may be interpreted broadly to include any type of computer-readable statement(s).

The SL-RS module 308 may be implemented via hardware, software, or combinations thereof. For example, the SL-RS module 308 may be implemented as a processor, circuit, and/or instructions 306 stored in the memory 304 and executed by the processor 302. In some aspects, the SL-RS module 308 can be integrated within the modem subsystem 312. For example, the SL-RS module 308 can be implemented by a combination of software components (e.g., executed by a DSP or a general processor) and hardware components (e.g., logic gates and circuitry) within the modem subsystem 312. The SL-RS module 308 may communicate with one or more components of UE 300 to implement various aspects of the present disclosure, for example, aspects of FIGS. 5-12.

The SL-RS module 308 may be configured to perform various functions related to sidelink transmissions between UEs. Such functions may include the designation of sidelink resources, sidelink reference signals, parameters of sidelink references signals, beam training procedures, or any other functions. In some examples, the SL-RS module 308 may be configured to determine resources for a sidelink reference signal. The SL-RS module 308 may identify available resources and determine resources for a sidelink reference signal based on the identified available resources as well as the priority of different transmissions, signal quality, etc. In some examples, the SL-RS module 308 may transmit sidelink reference signal parameters to UEs participating in a data transmission. In some examples, the SL-RS module 308 may be configured to receive and implement sidelink reference signal parameters.

The SL-RS module 308 may additionally be configured to perform beam training procedures including but not limited to generating and transmitting sidelink reference signals according to multiple training beams, analyzing and/or measuring signal quality associated with received sidelink references signals associated with different training beams, selecting one or more optimal beams for sidelink communication, generating beam training reports, transmitting beam training reports, receiving beam training reports, and/or providing instructions regarding implementation of beam training reports.

The UE 300 may be any one or more of a transmitting UE, a receiving UE, or a master UE depending on what sidelink group or groups the UE 300 is involved with. As a master UE, the UE 300 may be responsible for making the determinations related to sidelink reference signal parameters discussed herein, as well as controlling the configuration of any RISs that may be involved (or communicating with the controller of the RIS to implement the desired parameters, including involving the RIS in beam training procedures with other UEs). The UE 300 may operate as different UE types with different groups (e.g., either concurrently or at different times).

As shown, the transceiver 310 may include the modem subsystem 312 and the RF unit 314. The transceiver 310 can be configured to communicate bi-directionally with other devices, such as the BSs 105. The modem subsystem 312 may be configured to modulate and/or encode the data from the memory 304 and/or the SL-RS module 308 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data (e.g., channel sensing reports, PUCCH UCI, PUSCH data, etc.) of transmissions originating from another source such as a UE 115, a BS 105, or an anchor. The RF unit 314 may be further configured to perform analog beamforming in conjunction with the digital beamforming. Although shown as integrated together in transceiver 310, the modem subsystem 312 and the RF unit 314 may be separate devices that are coupled together at the UE 300 to enable the UE 300 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., RRC table(s) for channel access configurations, scheduling grants, channel access configuration activation, timing advance configurations, RRC configurations, PUSCH configurations, SRS resource configurations, PUCCH configurations, BWP configurations, PDSCH data, PDCCH DCI, sidelink configurations, etc.) to the SL-RS module 308 for processing. The antennas 316 may include multiple antennas of similar or different designs in order to sustain multiple transmission links.

In an aspect, the UE 300 can include multiple transceivers 310 implementing different RATs (e.g., NR and LTE). In an aspect, the UE 300 can include a single transceiver 310 implementing multiple RATs (e.g., NR and LTE). In an aspect, the transceiver 310 can include various components, where different combinations of components can implement different RATs.

Further, in some aspects, the processor 302 is coupled to the memory 304 and the transceiver 310. The processor 302 is configured to determine, under control of the SL-RS module 308, resources and/or parameters of sidelink reference signals, analyze and/or measure signal quality of references signals associated with different training beams, select optimal beams, generate, transmit, and/or receive beam training reports, implement reference signal parameters, and/or otherwise facilitate the transmission of data over sidelink.

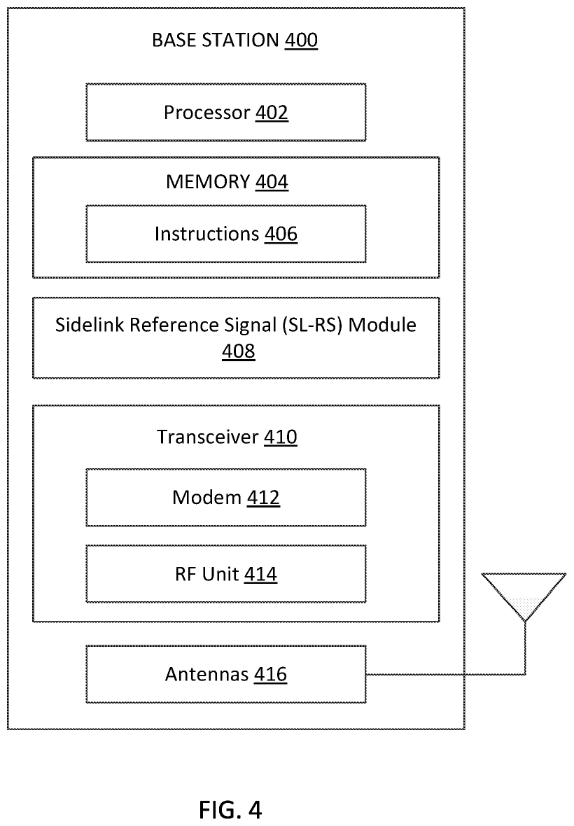

FIG. 4 is a block diagram of an exemplary BS 400 according to some aspects of the present disclosure. The BS 400 may be a BS 105 as discussed in FIG. 1, and/or a transmission reception point (TRP). For example, the BS 400 may be configured as one of multiple TRPs in a network configured for communication with at least one UE, such as one of the UEs 115. As shown, the BS 400 may include a processor 402, a memory 404, a sidelink reference signal (SL-RS) module 408, a transceiver 410 including a modem subsystem 312 and a RF unit 414, and one or more antennas 416. These elements may be coupled with one another. The term “coupled” may refer to directly or indirectly coupled or connected to one or more intervening elements. For instance, these elements may be in direct or indirect communication with each other, for example via one or more buses.

The processor 402 may have various features as a specific-type processor. For example, these may include a CPU, a DSP, an ASIC, a controller, an FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 5-12. Instructions 406 may also be referred to as program code. The program code may cause a wireless communications device to perform these operations, for example by causing one or more processors (such as processor 402) to control or command the wireless communications device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SL-RS module 408 may be implemented via hardware, software, or combinations thereof. For example, the SL-RS module 408 may be implemented as a processor, circuit, and/or instructions 406 stored in the memory 404 and executed by the processor 402. In some examples, the SL-RS module 408 can be integrated within the modem subsystem 312. For example, the SL-RS module 408 can be implemented by a combination of software components (e.g., executed by a DSP or a general processor) and hardware components (e.g., logic gates and circuitry) within the modem subsystem 312. The SL-RS module 408 may communicate with one or more components of BS 400 to implement various aspects of the present disclosure, for example, aspects of FIGS. 5-12.

The SL-RS module 408 may be configured to perform various functions related to facilitating sidelink transmissions between UEs in communication with the BS 400 as well as UEs which are not in communication with the BS 400 but are in communication with UEs which are in communication with the BS 400. Such functions may include the designation of one or more resource pools, designation of sidelink resources, sidelink reference signals, parameters of sidelink references signals, beam training procedures, or any other functions. In some examples, the SL-RS module 408 may be configured to determine resources for a sidelink reference signal (e.g., one or more resource pools, report configuration per resource pool or across pools, etc.). The SL-RS module 308 may identify available resources and determine resources for a sidelink reference signal based on the identified available resources as well as the priority of different transmissions, signal quality, etc. In some examples, the SL-RS module 408 may transmit sidelink reference signal parameters to UEs participating in a data transmission. For example, in mode-1 scenarios the BS 400 may server as the “master UE” for the UEs engaged in sidelink communications according to embodiments of the present disclosure, such that the transmitting UEs and the receiving UE are configured by the BS 400 (by the SL-RS module 408). For any UEs outside of coverage of the BS 400, the configuration parameters may be conveyed via a relay UE. Further, if any RIS (or similar) device is included, the BS 400 communicates with the RIS controller to configure the RIS to the best beam(s).

As shown, the transceiver 410 may include the modem subsystem 412 and the RF unit 414. The transceiver 410 can be configured to communicate bi-directionally with other devices, such as the UEs 115 and/or BS 400 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., RRC table(s) for channel access configurations, scheduling grants, channel access configuration activation, RRC configurations, PDSCH data, PDCCH DCI, RACH Preamble Assignments, random access messages, sidelink resource pool configuration, sidelink reference signal parameter configuration, etc.) from the modem subsystem 412 (on outbound transmissions) or of transmissions originating from another source such as a UE 115. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 400 to enable the BS 400 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices and provide the received data messages for processing and/or demodulation at the transceiver 410. The transceiver 410 may provide the demodulated and decoded data (e.g., PRACH messages, channel sensing reports, PUCCH UCI, PUSCH data, etc.) to the SL-RS module 408 for processing. The antennas 416 may include multiple antennas of similar or different designs in order to sustain multiple transmission links.

In an aspect, the BS 400 can include multiple transceivers 410 implementing different RATs (e.g., NR and LTE). In an aspect, the BS 400 can include a single transceiver 410 implementing multiple RATs (e.g., NR and LTE). In an aspect, the transceiver 410 can include various components, where different combinations of components can implement different RATs.

Further, in some aspects, the processor 402 is coupled to the memory 404 and the transceiver 410. The processor 402 is configured to communicate, with a second wireless communications device via the transceiver 410, a plurality of channel access configurations. The processor 402 is further configured to communicate, with the second wireless communications device via the transceiver 410, a scheduling grant for communicating a communication signal in an unlicensed band, where the scheduling grant includes an indication of a first channel access configuration of the plurality of channel access configurations.

FIG. 5 illustrates a communication scenario 500 involving multiple transmitting UEs and a receiving UE, according to some aspects of the present disclosure. The multiple transmitting UEs illustrated in FIG. 5 include transmitting UE 115₁ and transmitting UE 115ₙ. The UEs 115₁ and 115ₙ have each established a sidelink connection with a receiving UE 115_{R} as shown by the lines 512 and 514 respectively. It is to be understood, however, that any number of transmitting UEs may establish communication with the receiving UE 115_{R} and the principles described herein applied thereto. As shown by the pattern 515₁ corresponding to the UE 115₁ as well as the pattern 515ₙ corresponding to the UE 115ₙ, any of the transmitting UEs may transmit signals, such as reference signals in multiple directions. For example, signals, may be transmitted in the directions shown by the arrows 512 and 514 as well as in any other direction.

To optimize communication between the transmitting UEs 115₁ and 115ₙ with the receiving UE 115_{R}, beam training may be performed to select an optimal beam for each transmitting UE for data transmission (e.g., TB transmission as described herein). As shown by the beam pattern 515₁ corresponding to the UE 115₁ and the beam pattern 515ₙ corresponding to the UE 115ₙ, the transmitting UEs 115₁ and 115ₙ may be capable of adjusting beams associated with data transmission. This may be accomplished in various ways including but not limited to adjusting the direction of propagation of emitted waves, amplitude, gain, delays, or any other parameters of transmitted data.

In some instances, the transmitting UEs may be designated to jointly transmit a single TB to the receiving UE 115_{R} (e.g., coherent transmission of data from multiple sources), designated to transmit different TBs than each other, or designated to transmit a joint TB. To optimize transmission in any of these scenarios, beam training may be performed to determine the optimum beam corresponding to each transmitting UE 115₁ and 115ₙ, or to the transmitting UEs collectively. To perform beam training, each transmitting UE 115₁ and 115ₙ may transmit a sidelink reference signal (SL-RS) to the receiving UE 115_{R}. In some cases, the SL-RS transmitted may be a modified SL-RS, including for example the addition of a cyclic shift, and/or the manipulation of the comb offset and/or increasing the density per RB.

To ensure proper transmission of the SL-RS, various parameters of the SL-RS transmission are determined and agreed upon between the devices participating in the sidelink communication (in FIG. 5's example, UEs 115₁-115ₙ and UE 115_{R}). These parameters include, but are not limited to, resources to be used to transmit the SL-RS including e.g., time-frequency allocations, the number of ports as well as which ports are to be used, comb offsets, cyclic shifts (CSs) (including what value(s) to use), as well as report configurations (report configs) corresponding to the subsequent beam training report, and/or any other suitable parameters.

To determine parameters of beam training between multiple transmitting UEs and a receiving UE, a master wireless communications device may be designated. The master wireless communications device may be one of the transmitting UEs (e.g., any of UEs 115₁ to 115ₙ), the receiving UE (e.g., UE 115_{R}), a BS (e.g., the BS 105_{g} of FIG. 5 operating in mode-1 RRA), another UE (e.g., a controlling, primary, or programmable logic controller (PLC) UE in SL), or any other wireless communications device. The master wireless communications device may control the signaling and selection of resources, transmission parameters, SL-RS parameters, or any other settings or parameters relating to beam training or transmission between multiple transmitting UEs and a receiving UE. Again, these are referred to herein generally as sidelink reference signal parameters and may include all or a subset of parameters discussed herein. The master wireless communications device may transmit these parameters to all transmitting UEs, the receiving UE, and/or a BS.

In some examples, BS 105g may configure report configs per resource pool (RP); alternatively, the report configs may be common across pools using RRC/MAC-CE. The BS 105g may then communicate with the master wireless communications device (e.g., a UE 115 of the Tx-UEs 115₁-115ₙ or the Rx-UE 115_{R}), and the master wireless communications device may configure the other nodes with the used report config and SL-RS resource (e.g., all as included in a sidelink reference signal parameter transmission, or multiple such transmissions). The master wireless communications device may configure the other nodes using SCI (e.g., SCI1 or SCI2), a new SCI in PSSCH, dedicated PSSCH, PC5-MAC-CE, or PC5-RRC.

Beam training may be performed separately or jointly for the various scenarios where multiple transmitting UEs (e.g., the UE 115₁ and the UE 115ₙ) are designated to transmit the same TB, different TBs, or a joint TB to the receiving UE 115_{R}. In some aspects, the master UE may determine whether joint training or separate training will be used for beam training of multiple transmitting UEs. The master UE may make this determination based on the TB(s) to be transmitted (e.g., different TBs, a joint TB, or a same TB), as well as other needs of the transmission or training, SINR, or other factors.

For separate beam training of transmitting UEs assigned to transmit the same TB, the transmitting UEs may receive an indication from the master wireless communications device to transmit an SL-RS to the UE 115_{R} using one or more transmission parameters. For example, an SL-RS signal transmitted by the Tx-UE 115₁ during a beam training procedure may be described as h₁s₁+c₁, where h₁ corresponds to the channel by which the UE 115₁'s signal is transmitted, s₁ specifies the signal being transmitted, and c₁ corresponds to noise associated with the transmission on the channel h₁. In like manner, an SL-RS signal transmitted by the Tx-UE 115ₙ may be described as hₙs₁+cₙ, hₙ being the channel from UE 115ₙ because the transmitting UEs are trained to transmit the same TB, s₁ being the same as from UE 115₁ because the UEs are transmitting the same TB, and cₙ corresponding to the noise associated with transmission on the channel hₙ. Any additional transmitting UEs 115 may also transmit similar SL-RS signals according to the same pattern.

When these signals are received by the Rx-UE 115_{R}, a summation of these signals may be described as s (h₁+ . . . +hₙ)+(c₁+ . . . +cₙ). Because the same signal is sent by each transmitting UE, the signal, s₁, may have an increased signal-to-interference ratio due to diversity gain proportional to the number of transmitting UEs, n. However, because the transmitting UEs 115₁-115ₙ may have transmitted the SL-RS signal using different parameters than each other (e.g., resources, comb offsets, CSs, etc.), the Rx-UE 115_{R} may differentiate between signals sent by different transmitting UEs. For example, even when multiplexing on the same time/frequency resources, according to embodiments of the present disclosure the same SL-RS sent by each transmitting UE may use different cyclic shifts from each other to distinguish from one another. Because the transmitting UEs are being trained to transmit the same TB, the receiving UE 115_{R} may treat the signals as originating from a single source and the summation may be ns₁+(c₁+ . . . +cₙ), where h corresponds to the channels of the transmitting UEs. In this case, Rx-UE 115_{R} engages in additional processing to combine signals received from separate UEs. In addition, the error, c, from each transmitting UE (e.g., c₁, cₙ, etc.) is added. As a result, separate training of transmitting UEs for transmission of the same TB may include additional inefficiency due to added processing required by the Rx UE 115_{R}. Separate training of transmitting UEs for transmission of the same TB may also introduce additional error due to the combination of error of all transmitting UEs, resulting in power loss. For UEs transmitting the same TB, these inefficiencies and increased errors are resolved by joint training.

For joint beam training for transmitting the same TB, transmitting UEs may receive an indication from the master wireless communications device to transmit an SL-RS to the UE 115_{R} using one or more transmission parameters (e.g., resources, cyclic shifts, etc.). The master wireless communications device may assign the same transmission parameters to each transmitting UE (e.g., including cyclic shift being the same), or may assign a different transmission parameter, such as cyclic shift. Thus, each transmitting UE may transmit the same SL-RS with either the same or different cyclic shifts. Where the same cyclic shift is used for each SL-RS, the receiving UE 115_{R} will perceive the signals from the transmitting UEs as a single signal from a single source. This may be described as nhs+c, where n corresponds to the number of transmitting UEs, h corresponds to the (undistinguishable between transmitting UEs when same CS is used) channel, s specifies the signal, and c corresponds to noise associated with the transmission on the channel h. In this case, beam training may be accomplished with less power loss because the error value c is taken into account just once, not with each separate channel's transmission as occurs with separate training. In scenarios where the same SL-RS is sent, but with different cyclic shifts, the above still holds true as the receiving UE 115_{R} may still treat the (now distinguishable) channels as one for receipt of the coherent transmission, with the option of distinguishing the channels if desired or needed.

With respect to different TBs or joint TB transmission, the UEs involved in sidelink transmissions in the example in FIG. 5 may jointly decide whether individual beam training (also referred to as separate sounding or separate training) or joint beam training (also referred to as joint sounding) is best for training the transmitting beams towards the receiving UE, regardless of whether a RIS is involved or not as well.

For transmission of a different TB or the joint TB, the transmitting UEs 115₁-115ₙ may receive an indication from the master wireless communications device to transmit an SL-RS to the UE 115_{R} using one or more transmission parameters (e.g., resources, CSs, etc.). For either joint beam training or separate beam training, according to aspects of the present disclosure the transmitting UEs 115₁-115ₙ are assigned one or more differing transmission parameters so that the receiving UE 115_{R} is able to distinguish between transmitters. Thus, the receiving UE 115_{R} may differentiate which signals originated from which transmitting UEs based on the parameters of the reference signal, such as unique cyclic shift, comb offset, etc. assigned to each reference signal. The transmissions from all transmitting UEs at the receiving UE 115_{R} may be described as (h₁+ . . . +hₙ)s+c, where n corresponds to the number of transmitting UEs, h₁ corresponds to the channel from the UE 115₁, hₙ corresponds to the channel from the UE 115ₙ, s specifies the signal, and c corresponds to noise associated with the transmission on the joint channel (h₁+ . . . +hₙ). As noted previously, joint beam training may result in less power loss because the error value c is taken into account just once, not with each separate channel's transmission as occurs with separate training.

In some aspects, efficiency of training of multiple transmitting UEs may be increased due to multiplexing of transmitting UEs' sidelink reference signals. This may be a result of introducing cyclic shifts to SL-RS, the configuration of more comb offsets and/or density for SL-RS, and/or allowing report config configurations for SL-RS.

The master UE may, as noted above, further configure the report config for beam training reports (i.e., in addition to configuring the SL-RS parameters). For example, the master UE may define the report configuration index (or indices), such as for different possible report configurations as provisioned by a server BS. The index may identify one of potentially multiple possible report configurations that define different aspects for the contents of the report, what CQI tables to use, etc. For example, the BS may configure report configurations per resource pool, or across pools (e.g., using RRC and/or MAC-CE). Alternatively, the master UE may explicitly identify the contents of the report instead of using an index. The master UE may signal this configuration to the other UEs (including transmitting and/or receiving UEs, depending on what device is master UE) using SCI (e.g., SCI1 or SCI2), a new SCI in PSSCH, dedicated PSSCH, PC5-MAC-CE, or PC5-RRC, to name a few examples.

As configured for a beam training report, the receiving UE 115_{R}, upon receipt of the SL-RS from the multiple transmitting UEs 115₁-115ₙ, measures the channel(s) (one channel in the same TB scenario with no differentiation between SL-RS, multiple channels where cyclic shift and/or other parameters serve to distinguish the SL-RS from the different UEs) and prepares the appropriate beam training reports. The receiving UE 115_{R} transmits the beam training report(s) to transmitting UEs 115₁-115ₙ, the master UE, and/or the BS 105g. The appropriate precoders/codebooks are selected based on the results o the beam training report(s), and the transport block(s) is then transmitted per the given scenario (e.g., designated to transmit the same TB, different TBs, or a joint TB).

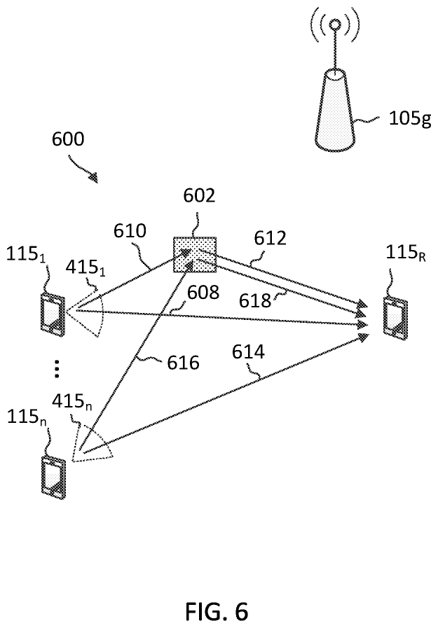

FIG. 6 illustrates a communication scenario 600 involving multiple transmitting UEs, a receiving UE, and a RIS, according to some aspects of the present disclosure. As shown in FIG. 6, aspects of the present disclosure may apply to communication scenarios in which multiple transmitting UEs and a receiving UE perform beam training procedures in conjunction with a RIS. In some scenarios, the presence of a RIS device, such as the RIS 602 shown in FIG. 6, may enhance the communication between transmitting UEs (e.g., the UEs 115₁, 115ₙ, etc.) with a receiving UE (e.g., the UE 115_{R}).

FIG. 6 includes a depiction of the RIS 602 along with the transmitting UEs 115₁ and 115ₙ and the receiving UE 115_{R}. As described with reference to FIG. 5, the transmitting UEs 115₁ and 115ₙ may establish communication with the receiving UE 115_{R}. As illustrated in FIG. 6, UEs 115₁ and 115ₙ may transmit reference signal(s) for the UE 115_{R} to receive. With regards to UE 115₁, while multiple arrows are shown leaving the UE 115₁, it should be understood that each of these may represent the same signal which has a wide enough beam or set of beams that it propagates in the illustrated directions, including a path that includes reflecting off the RIS 602 (identified as a RIS, but more generally a nearly-passive device, such as may also include amplify and forward relays). Similarly, while multiple arrows are shown leaving the UE 115ₙ, it should be understood that each of these may represent the same signal which has a wide enough beam or set of beams that it propagates in each of the illustrated directions and is able to reflect off the RIS 602. Only those aspects that differ from those of FIG. 5 as discussed above are addressed below.

RISs may also be referred to as reflectarrays, or (near-) passive MIMO arrays. A RIS may include a reflective surface configured to reflect signals to and from the transmitting/receiving devices. In some aspects, the RIS may include an array of reflectors configured to direct signal energy. A UE/BS may use the RIS by transmit and/or receive beamforming in a direction associated with the RIS. A RIS may be configured with parameters which affect its reflective properties. In addition to controlling the direction of reflection, a RIS may potentially shift the frequency of a reflected signal. The RIS 602 may be used to reflect the reference signal to be received by UE 115_{R}. In direction 610, the reference signal may reflect from RIS 602, creating a reflection in direction 612.

In direction 616, the reference signal may reflect from RIS 602, creating a reflection in direction 618. In some examples, the RIS 602 may alter the reflected signal in various ways, including, for example, by shifting the frequency of the reference signal. For example, training a RIS may involve transmitting a sequence of reference signals while adjusting RIS parameters. As devices move and channel conditions change, RISs may be retrained periodically and/or when it is determined that the communication channel is not providing a good enough connection.

Training may be performed such that training multiple RISs in parallel is possible, e.g. at the same time or approximately at the same time. For example, transmitting UEs 115₁ and 115ₙ may transmit respective SL-RS with a comb level equal to the number of potential RISs available to help the UEs. The availability of RISs may be indicated by a BS in a resource pool (RP) and/or as part of the bandwidth part (BWP) configuration. The comb-N reference signal may then be reflected in parallel by each of the RISs when each of the RISs receives the comb-N RS. Each RIS may be assigned to shift the frequency of the reference signal upon reflection by a different amount in increments of one or more resource elements. By shifting the frequency by a different amount at each RIS, when the receiving UE 115_{R} receives the various reflected signals, the receiving UE 115_{R} may know which RIS was used for each reflection based on the frequencies of the reflected signals. When the transmitting UE has a direct communication path to the receiving UE 115_{R}, then the direct path will have no frequency shift. In this case, a comb-N reference signal may be used to train N−1 RISs. When the transmitting UE does not have a direct communication path to the receiving UE 115_{R}, then one of the RISs may reflect without shifting the frequency of the reference signal. In this case, a comb-N reference signal may be used to train N RISs.

By the UEs 115₁ and 115ₙ respectively transmitting a sequence of such comb-N reference signals, each RIS may have parameters adjusted between transmitted comb-N reference signals so that each reference signal in the sequence is reflected by the RIS using different RIS parameters. By measuring the received signals that have been reflected with the adjusted parameters, the receiving UE 115_{R} may be able to distinguish among the available RISs and (upon comparing the results of the measured signals over time) determine which RISs, with which parameters, may provide the best received signal for a given channel. In further examples, the UEs 115₁ and 115ₙ transmitting respective sequences of reference signals for training may shift the offset of the comb signal pattern between each signal. In some aspects, the comb offset shifts one RE at each step. In other aspects, different patterns may be used for sweeping the comb offset such that signals sent in succession are spaced further in frequency.

After performing a training sequence, the receiving UE 115_{R} may generate a report which indicates the one or more RISs that provide desirable signal metric(s) (e.g., the best spectral efficiency, reference signal received power, reference signal received quality, signal to interference noise ratio, etc., including some combination of metrics), and the corresponding RIS parameters. The report may include other information such as the measurements. The report is sent to another device, such as the transmitting UE(s) or some UE which may control the RISs, which may then forward the report to the RISs, potentially after further refining the report (e.g. reducing which RISs are used). In some aspects, a UE is able to configure the RISs, and in other aspects, only a BS is able to configure the RISs. When only a BS is able to configure the RISs, UEs using the RISs for sidelink communication may send a report to a BS such that the BS may configure the RISs appropriately. The receiving UE 115_{R} may, itself, be the master UE in which case it transmits the commands to the RIS controller itself.

When configuring RISs as part of the signal path between UEs, the configuration message may be sent as a broadcast which is received by more than one RIS. In that case, the RIS which is to be configured may be identified in the configuration message. The identification, for example, may be in the form of a RIS ID, a comb offset, and/or a radio network temporary identifier (RNTI) (to name a few examples).

In some examples, the master wireless device (e.g., any of the UEs 115 and/or the BS 105g) may determine a configuration of the sidelink reference signal that is to be used by transmitting UEs 115₁ and 115ₙ and transmit the configuration to a controller of the RIS 602. In that regard, aspects of the present disclosure may include generating by a master wireless communications device, a sidelink reference signal configuration for a reconfigurable intelligent surface (RIS) controller. The RIS controller may be positioned between the master wireless communications device and another wireless communications device, such as a transmitting UE or a receiving UE. In some examples, the master wireless communications device may transmit the sidelink reference signal configuration to the RIS controller as well as to any other participating wireless communications devices, such as transmitting UEs, the receiving UE, or a BS. For example, the configuration may include an identification of the sidelink reference signal to be used by transmitting UEs 115₁ and 115ₙ, including the different parameter(s) of each SL-RS (such as different cyclic shifts, etc.). The configuration may also include the frequency shifts used to separate RISs from each other in the frequency domain. These shifts in frequency domain may be viewed as frequency watermarks associated with each RIS.

In some examples, the configuration may additionally include identification of initial beams to the RIS to assist the RIS 602 in identifying an optimal RIS configuration and/or beamformer. In some examples, the configuration may also include a zone ID of the receiving UE 115_{R}. This may assist the RIS 602 in initial beamforming and/or beam training a specific beam or set of beams for the Rx-UE 115_{R} from any one or all of the Tx UEs 115.

In mode-1 RRA, BS 105g can assign the SL-RS configurations to transmitting UEs 115₁ and 115ₙ and Rx-UE 115_{R}. The BS 105g may configure the resource per RRC or per RP (which is RRC configuration), then assign to each Tx-UE 115₁-115ₙ and to Rx-UE 115_{R}. The BS 105g transmits this assignment to the UEs that are within coverage of the BS 105g. For any node out-of-coverage, a primary/relay UE will handle the configuration delivery from the BS 105g. In addition, in mode-1 the BS 105g also communicates with the RIS 602's control the information discussed above with respect to the RIS 602. Accordingly, embodiments of the present disclosure will work in environments that also operate with RISs involved.

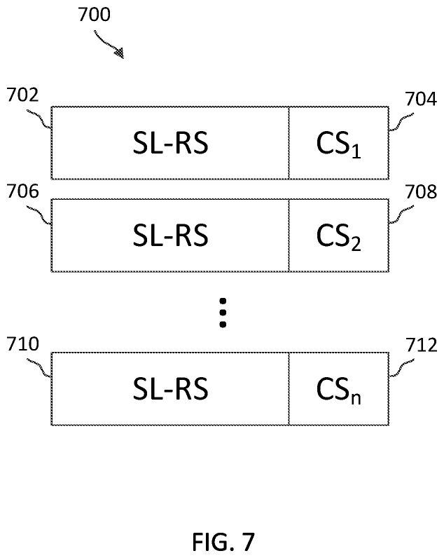

FIG. 7 is a block diagram 700 of sidelink reference signals corresponding to transmitting UEs, according to aspects of the present disclosure. The sidelink references signals shown in FIG. 7 illustrate one variation of side link parameters between transmitting UEs. For example, a SL-RS 702, a SL-RS 706, and a SL-RS 710 are shown. The SL-RS 702 may correspond to a sidelink reference signal transmitted by one transmitting UE (e.g., the UE 115₁ of FIG. 5), the SL-RS 706 may correspond to a sidelink reference signal transmitted by a different transmitting UE, and the SL-RS 710 may correspond to a sidelink reference signal transmitted by an additional different transmitting UE (e.g., the UE 115ₙ of FIG. 5). The SL-RS 702, SL-RS 706, and/or SL-RS 710 may be the same known sequence that is recognizable by receiving devices.

To enable a receiving device to differentiate these SL-RS from each other when multiplexed together (e.g., on the same time/frequency resources), each SL-RS 702, 706, and 710 may include a different cyclic shift (CS). Specifically, the SL-RS 702 may include CS₁ 704, the SL-RS 706 may include CS₂ 708, and the SL-RS 710 may include CSₙ 712. Each of CS₁ 704, CS₂ 708, and/or CSₙ 712 are typically distinct from each other, to enable the receiving device to distinguish which transmitting UE corresponds to each SL-RS received. In situations where the same TB (coherent transmission) is expected, the same CS may be assigned for each SL-RS, for reasons discussed previously. Otherwise, different CS may be assigned for each SL-RS. For example, each transmitting UE may select its own cyclic shift randomly from multiple available. Collisions may occur in this scenario, however. While this may be supportable in situations where a coherent TB transmission is subsequently expected, at other times (e.g., different TB or joint TB transmission) this may be undesirable. As such, when a collision occurs the training phase may be repeated, either with the transmitting UEs again randomly selecting cyclic shifts, or by being assigned a cyclic shift per some examples discussed below.

For example, the master UE may select the cyclic shifts for each of the transmitting UEs based on an identifier associated with the first wireless communications device. To avoid collision with other transmitting UEs, the master UE may select the set of CSs, e.g., CS₁ 704, CS₂ 708, and CSₙ 712 based on an identifier associated with the transmitting UEs. For example, the master UE may select the set of CSs, e.g., CS₁ 704, CS₂ 708, and CSₙ 712 based on an original source ID, a destination ID, a relaying/link ID associated with the TB, a Rx-UE zone ID, and/or all Tx-UEs and Rx-UE zone IDs. Alternatively, the master UE may allocate a larger set of CSs (larger than CS₁ 704, CS₂ 708, and CSₙ 712) and transmit an indication of this allocation to the transmitting UEs. Each Tx-UE may then select a CS based on its own ID and/or Tx-UE zone ID. Once selected, each Tx-UE may then notify the other Tx-UEs of its CS selection by RRC/MAC-CE, dedicated PSSCH, or SCI-2.

As previously described, the sidelink reference signals sent by the transmitting UEs to a receiving UE may be modified in various ways in addition to differing cyclic shifts. For example, each of the SL-RSs 702, 706, and 710 may be differentiated by the receiving UE by variations in comb offsets, density, resource allocation, report configurations, and/or other parameter.

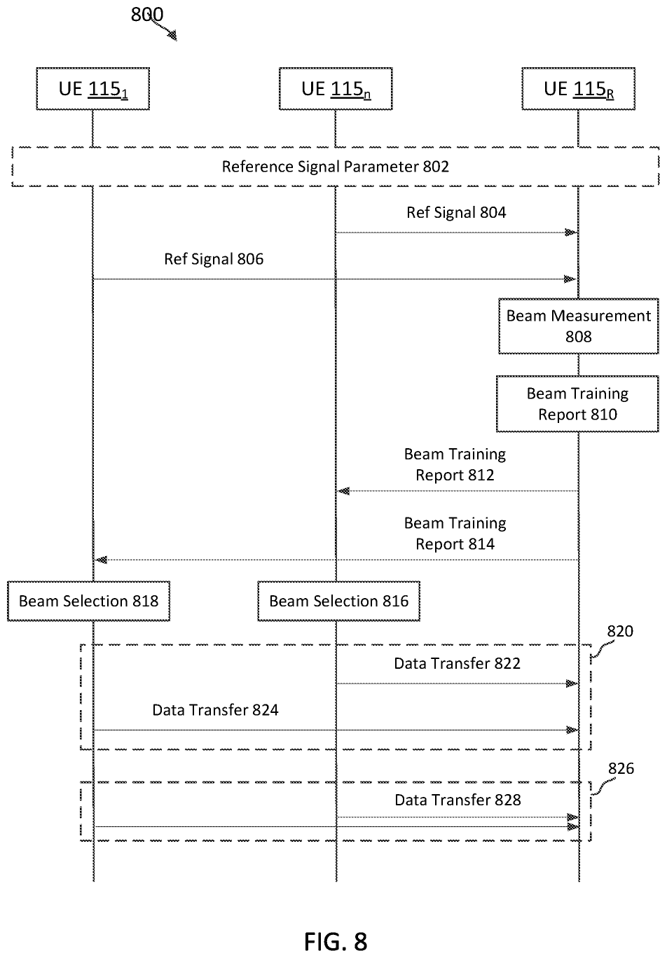

FIG. 8 is a signaling diagram 800 of a beam training method for multiple transmitting UEs and a receiving UE, according to aspects of the present disclosure. The diagram 800 may involve any of the transmitting UE 115₁, the transmitting UE 115ₙ, or the receiving UE 115_{R} as discussed with reference to FIGS. 1-6. Specifically, FIG. 5 is an example of a system which includes multiple UEs 115 communicating with a receiving UE 115_{R}. For simplicity of illustration and discussion, only two transmitting UEs are illustrated, but it should be understood that a larger number of transmitting UEs may be used to perform the same or similar methods.

In some aspects, the UEs 115₁, 115ₙ, and/or 115_{R} may utilize one or more components, such as the processor 302, the memory 304, the sidelink reference signal (SL-RS) module 308, the transceiver 310, the modem 312, and the one or more antennas 316 shown in FIG. 3. As illustrated, the signaling diagram 800 includes a number of enumerated actions, but aspects of FIG. 8 may include additional actions before, after, and between the enumerated actions. In some aspects, one or more of the enumerated actions may be omitted, combined together, or performed in a different order.

At action 802, a reference signal parameter is determined and transmitted. As shown by the dotted outline of the action 802 shown in FIG. 8, the reference signal parameter may be determined and transmitted by any of the devices UE 115₁, UE 115ₙ, or UE 115_{R}. In some examples, the action 802 may be performed by a master wireless device. For example, if the transmitting UE 115₁ is the master wireless device, the UE 115₁ may determine one or more reference signal parameters and transmit the reference signal parameter(s) to the other transmitting UE 115ₙ and the receiving UE 115_{R}. Either of the devices 115ₙ or 115_{R} may also perform this step in situations where they are respectively the master wireless device. In some examples, a base station (e.g., the BS 105g shown and described in FIG. 5) may perform action 802, such as in mode-1 situations. As previously described, the reference signal parameter may include designations of one or more of cyclic shifts, comb offsets, density, ports, resources, report configs, or any other parameters. The reference signal parameter transmitted to different UEs of the signaling diagram 800 shown may be the same or may differ. For example, for joint training of wireless devices for same TB transmissions, the reference signal parameter sent to the UEs may be the same, while for separate training (or joint training where differentiation between devices is desired), the reference signal parameter differs in any one or more of the ways previously described and discussed further below.

For purposes of describing the subsequent actions of the signaling diagram 800, the UE 115₁ will be described as the master wireless device, although any of the devices shown or previously described may alternatively be the master wireless device (including BS 105g that is not shown in FIG. 8).

At action 804, the transmitting UE 115ₙ transmits a reference signal to the receiving UE 115_{R}. The transmitting UE 115ₙ may transmit the reference signal according to the reference signal parameter the UE 115ₙ received from the UE 115₁ at action 802.

At action 806, the transmitting UE 115₁ transmits a reference signal to the receiving UE 115_{R}. The transmitting UE 115₁ may likewise transmit the reference signal according to the reference signal parameter determined by the UE 115₁ at action 802.

It is noted that the actions 804 and 806 may occur simultaneously or at different times and in any order. For example, the UE 115₁ may transmit a reference signal to the UE 115_{R} before the UE 115ₙ transmits a reference signal, etc. Further, while illustrated as one reference signal transmitted at each of 804 and 806, in some situations such as joint TB beam training, this may involve beam sweeping across multiple SL-RS, and the UE 115_{R} checking if signals are coherently added or not.

At action 808, the UE 115_{R} measures the SL-RS it receives. For example, the receiving UE 115_{R} may measure a received signal quality (e.g., a reference signal received power (RSRP)) of each SL-RS transmitted from each of UE 115₁ and UE 115ₙ.

At action 810, the UE 115_{R} generates a beam training report based on measurements performed at action 808. In some examples, the UE 115_{R} may generate multiple beam training reports, e.g. a unique beam training report for each transmitting UE (e.g., the UEs 115₁ and 115ₙ). In some examples, the UE 115_{R} generates a single beam training report that includes information for each transmitting UE (or a subset of information for each transmitting UE).

At action 812, the UE 115_{R} transmits the beam training report to the UE 115ₙ.

At action 814, the UE 115_{R} transmits the beam training report to the UE 115₁. Similar to the actions 804 and 806, the actions 812 and 814 may occur simultaneously or at different times and in any order. For example, the UE 115_{R} may transmit the beam training report to the UE 115₁ before transmitting the beam training report to the UE 115ₙ.

At action 818, the UE 115₁ may select a beam based on the beam training report. In some examples, the UE 115₁ may select a beam that corresponds to the highest signal quality, including optimum RSRP.

Similarly, at action 816, the UE 115ₙ may select a beam based on the beam training report. Like the actions 804 and 806, and the actions 812 and 814, the actions 816 and 818 may be performed simultaneously or at different times. Moreover, while actions 818 and 820 are described with respect to the transmitting UE selecting a beam, in other examples this may instead involve the transmitting UEs implementing a selection of a beam as recommended by the UE 115_{R} as part of its beam training report at action 810.

At action 820, the UEs 115₁ and 115ₙ may transmit data to the UE 115_{R} using the beams selected at actions 816 and 818 (respectively shown as actions 822 and 824 within action 820). Action 820 is illustrated in dashed lines as it may instead occur as action 826. For example, action 820 may correspond to a signaling diagram for multiple transmitting UEs sending different TBs or a joint TB to the receiving UE_{R}. In other words, in one scenario the data transfer 822 includes one TB (according to the beam selected at action 816), while data transfer 824 includes a different TB (according to the beam selected at action 818). And in another scenario, the data transfer 822 includes one part of a TB, while data transfer 824 includes another part of the same TB (joint TB transmission, again with the beams selected at actions 816 and 818 respectively).

Action 826 shown below action 820 may be an alternative to action 820, corresponding to a scenario where multiple transmitting UEs transmit the same TB to the receiving UE_{R}. This is illustrated as data transfer 828, with each of the transmitting UEs transmitting the same TB, according to the beam selected at action 816 and 818 respectively. In the scenario described by action 826, the receiving UE 115_{R} may not recognize that the received TB is being sent by multiple transmitting UEs as opposed to a single transmitting UEs because both transmitting UEs 115₁ and 115ₙ use the same parameters to transmit the TB.

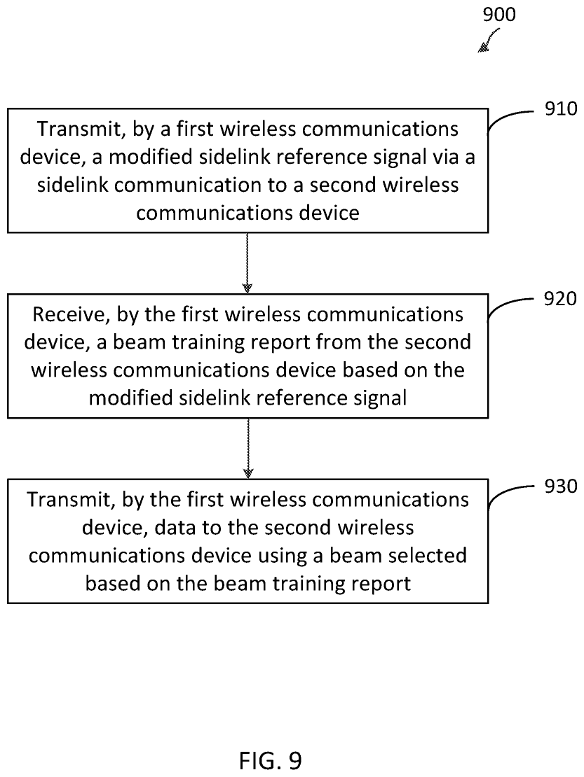

FIG. 9 is a flow diagram of a wireless communication method, according to some aspects of the present disclosure. Aspects of the method 900 can be executed by a computing device (e.g., a processor, processing circuit, and/or other suitable component) of a wireless communications device or other suitable means for performing the aspects. For example, a wireless communications device, such as the UE 115, may utilize one or more components, such as the processor 302, the memory 304, the sidelink reference signal module 308, the transceiver 310, the modem 312, and the one or more antennas 316, to execute aspects of method 900. The method 900 may employ similar mechanisms as the actions described with respect to FIGS. 4-8. As illustrated, the method 900 includes a number of enumerated aspects, but the method 900 may include additional aspects before, after, and/or in between the enumerated aspects. In some aspects, one or more of the enumerated aspects may be omitted or performed in a different order.

At block 910, the method 900 includes a wireless communications device (e.g., a UE 115) transmitting a modified sidelink reference signal via a sidelink communication to a second wireless communications device. The modified sidelink reference signal may be modified in any number of ways. For example, the modified sidelink reference signal may include a cyclic shift. In some examples, the modified sidelink reference signal may also include a comb offset, increased density, report configurations for the sidelink references signals, or other parameters. Any of these modifications may improve the modified sidelink reference signal and make beam training between multiple transmitting UEs and a receiving UE more efficient.

To determine parameters of beam training between multiple transmitting UEs and one receiving UE, a master wireless communications device may be designated. The master wireless communications device may be one of the transmitting UEs, the receiving UE, a BS, another UE, or any other wireless communications device. The master wireless communications device may control the signaling and selection of resources, transmission parameters, SL-RS parameters, or any other settings or parameters relating to beam training or transmission between multiple transmitting UEs and a receiving UE. The master wireless communications device may transmit these parameters to all transmitting UEs, the receiving UE, a BS, and/or a RIS controller.

The parameters of beam training between multiple transmitting UEs and a receiving UE may be selected in various ways. In some aspects, transmitting the modified sidelink reference signal may be based on a parameter for the sidelink reference signal which was generated, selected, and/or assigned by the master wireless communications device. In some examples, the parameter may include an identification of one or more resources for use in beam training with the receiving UE, an identification of a number ports and a time/frequency allocation for the modified sidelink reference signal and the beam training report an identification of a configuration for the beam training report, or and other parameter

In some aspects of the method 900, the parameters of beam training and/or data transmission of multiple transmitting UEs and a receiving UE may be determined to facilitate the transmitting UEs all jointly transmitting the same transport block (TB). In other examples, the parameters may facilitate the transmitting UEs each transmitting different TBs, or transmitting a joint TB.

In some aspects, data may be transmitted by a first wireless communications device (e.g., one of the transmitting UEs) to a second wireless communications device (e.g., the receiving UE). The data transmitted by one transmitting UE may include a same TB to those transmitted by at least one other transmitting UE. When multiple wireless communications devices transmit the same TB, the first wireless communications device may use a same cyclic shift for the modified sidelink reference signal as used by the at least one other wireless communications device. In examples in which a single TB is transmitted by multiple transmitting UEs, the transmitted signal may be amplified by diversity gain. In some examples, the data of the single TB transmitted may be obtained from a source UE (e.g., the master wireless communications device or another wireless communications device) in a first hop relaying in sidelink. In some examples, all transmitting UEs transmitting the same TB may use the same ports or different ports. In some examples, all transmitting UEs may use the same comb offset and the same cyclic shift. When multiple transmitting wireless communications devices jointly transmit a single TB, it may be referred to as joint transmission, coherent transmission, or by any other term. During beam training, each UE may be assigned the same CS to train in a single frequency network (SFN) manner. In some examples, transmitting UEs may use different resources, cyclic shifts, ports, comb offsets, etc. to transmit the same TB, as described previously with reference to FIG. 5.

In some aspects, data transmitted by the first wireless communications device (e.g., one of the transmitting UEs) to the second wireless communications device (e.g., the receiving UE) may include a different transport block to those transmitted by one or more other transmitting UEs. In this example, the first transmitting UE may use at least one of a different cyclic shift or different comb offset for the modified sidelink reference signal as used by the other transmitting UE.

In an example in which different TBs are transmitted to an Rx-UE, joint beam training may allow each transmitting UE to determine the optimized beam to maximize performance and reduce interference. In some examples, the master wireless communications device can send SL-RS information (e.g., time-frequency resources, CS, comb offsets, report configurations, etc.) to transmitting UEs. The transmitting UEs may then use different (e.g., orthogonal) resources to beam train and transmit data. In some examples, the master wireless communications device can send indices for the different SL-RS resources, configurations such as CS, comb-offsets, ports, etc., or other instructions to be used by Tx-UEs. The transmitting UEs may use the same ports, same comb offset, and same resources with different cyclic shifts to transmit different TBs.

In some examples, the receiving UE may be the master wireless communications device and may transmit such assignments to the transmitting UEs. In examples in which transmitting UEs transmit different TBs, a MU-MIMO structure may be implemented.

In some aspects of the present disclosure, multiple transmitting UEs may transmit a joint TB. In some aspects, data transmitted by the first wireless communications device (e.g., one of the transmitting UEs) may include a first portion of a joint transport block. In some aspects, a second portion of the joint transport block may be transmitted by at least one other wireless communications device (e.g., another transmitting UE). A joint TB transmission by multiple transmitting UEs may include determining a number of layers and CWs are determined based on a distributed MIMO structure. For example, different layers of a joint TB may be transmitted by different UEs.

For joint beam training, a master UE (or a UE reserving the resources for joint beam determination or RIS training), can indicate which resources are used for training (e.g., SL-RS resources) as well as report configuration indices. In some aspects, transmitting a modified sidelink reference signal for transmitting a joint TB may include sweeping across multiple sidelink reference signals to the second wireless communications device. In some examples, training for joint TB transmission may include beam sweeping across multiple sidelink reference signals and determining whether signals add coherently. In some examples, a joint TB may be transmitted in an SFN manner.

Cyclic shifts for SL-RS for multiple transmitting UEs may be selected in a variety of ways. In some aspects, the first wireless communications device (e.g., one of the transmitting UEs) may select a cyclic shift or comb offset based on a random selection. In a sidelink communication, the transmitting UEs may select one or a set of the CSs randomly. In some instances, two UEs may select the same CS or CS sets. In this case, collision occurs, and the signal will be received by the receiving UE as if the two transmitting UEs are trained together. Collision may be beneficial in the example of training for transmitting the same TB. However, in the case of training for transmitting different or joint TBs, the training phase may be repeated if collision occurs.

In some aspects, the first wireless communications device (e.g., one of the transmitting UEs) may select a cyclic shift or comb offset based on an identifier of that transmitting UE. To avoid collision with other transmitting UEs, the master UE may select the set of CSs or comb-offsets based on the transmitting UEs. For example, the master UE may select the set of CSs or comb-offsets based on an original source ID, a destination ID, a relaying/link ID associated with the TB, a Rx-UE zone ID, and/or all Tx-UEs and Rx-UE zone IDs. The selected set of CSs may then be transmitted by the master UE to the transmitting UEs and the receiving UE, e.g. via an SCI such as SCI-2.

In some aspects, to avoid collision among UEs transmitting different TBs, the master UE may allocate a set of CSs and comb-offsets and transmit an indication of this allocation to the transmitting UEs. Each Tx-UE may then select the CS or comb-offsets based on its own ID and/or Tx-UE zone ID. Each Tx-UE may then notify other Tx-UEs of its CS or comb-offset selection by RRC/MAC-CE, dedicated PSSCH, or SCI-2.

At block 920, the wireless communications device (e.g., a UE 115) receives a beam training report from the second wireless communications device based on the modified sidelink reference signal. The beam training report received by the first wireless communications device may indicate a beam, including various beam forming parameters, corresponding to a sidelink reference signal with the highest transmission quality.

In examples in which joint training is performed in preparation for multiple transmitting UEs transmitting a same TB, a beam training report may be transmitted by the receiving UE to each transmitting UE. In some examples, the receiving UE may generate and transmit a unique beam training report for each transmitting UE. In other examples, (e.g., in examples in which the same TB is to be transmitted by all transmitting UEs and the transmitting UEs are trained using the same resources, ports, cyclic shifts, and comb offsets), the receiving UE may generate and transmit a single beam training report. In such cases, each transmitting UE may receive the same beam training report from the receiving UE. In some aspects, each transmitting UE may determine the optimal beam for transmitting the same TB based on this same beam training report.

In examples in which joint training is performed for transmitting different TBs or joint TBs, the receiving UE may generate and transmit one or more different beam training reports. In some examples, the receiving UE may generate and transmit a unique beam training report for each transmitting UE. The transmitting UEs may then each select the optimized beam for data transmission based on their respective beam training reports.

At block 930, the wireless communications device (e.g., a UE 115) transmits data to the second wireless communications device using a beam selected based on the beam training report. The transmitted data may be of any suitable type. The transmitted data may be a single TB jointly transmitted with other transmitting UEs, different TBs transmitted in a multiplexed fashion with other transmitting UEs, or a joint TB transmitted with other transmitting UEs.

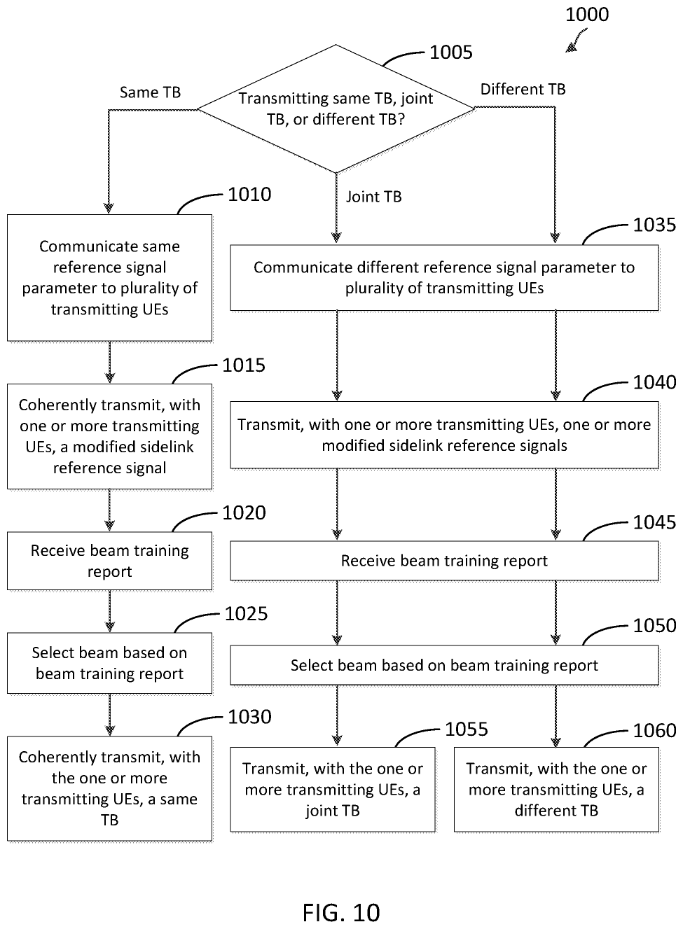

FIG. 10 is a flow diagram of a wireless communication method 1000, according to some aspects of the present disclosure. Aspects of the method 1000 can be executed by a computing device (e.g., a processor, processing circuit, and/or other suitable component) of a wireless communications device or other suitable means for performing the aspects. For example, a wireless communications device, such as the UE 115, may utilize one or more components, such as the processor 302, the memory 304, the sidelink reference signal module 308, the transceiver 310, the modem 312, and the one or more antennas 316, to execute aspects of method 1000. The method 1000 may employ similar mechanisms as the actions described with respect to FIGS. 4-8. As illustrated, the method 1000 includes a number of enumerated aspects, but the method 1000 may include additional aspects before, after, and/or in between the enumerated aspects. In some aspects, one or more of the enumerated aspects may be omitted or performed in a different order.

The method 1000 may correspond to a communication scenario in which multiple transmitting UEs are configured to perform beam training and transmit one or more TBs to a receiving UE, as described previously. At block 1005, the method 1000 includes determining whether the multiple transmitting UEs are to transmit a same TB, a joint TB, or different TBs. In some examples, this determination may be made by the master wireless communications device. In some examples, this determination may be made by a base station or the receiving UE and may be transmitted to the master wireless communications device.

If it is determined that a same TB is to be transmitted by multiple transmitting UEs to the receiving UE, the method 1000 may proceed to the block 1010. If, however, it is determined that a joint TB or different TBs are to be transmitted to the receiving UE, the method 1000 may proceed to the block 1035 in either scenario.

At block 1010, each of the transmitting UEs and the receiving UE may communicate a same reference signal parameter depending on each UE's role in the communication scheme. For example, if one of the UEs is designated as the master wireless communications device, that UE would determine and transmit the reference signal parameter to the other participating UEs. If a UE is not the master wireless communications device, at block 1010, that UE may receive the reference signal parameter.

At block 1015, the one or more transmitting UEs coherently transmit a modified sidelink reference signal. Aspects of the block 1015 may be similar to the block 910 of method 900 described with reference to FIG. 9. Specifically, the modified sidelink reference signal may be modified in any number of ways. For example, the modified sidelink reference signal may include a cyclic shift, differing or increased comb offsets, increased density, report configurations, designation of ports or resources for the sidelink references signals, or any other parameters. Any of these modifications may improve the modified sidelink reference signal and make beam training between multiple transmitting UEs and one receiving UE more efficient.

Because, at block 1015, multiple transmitting UEs are trained to transmit the same TB, the transmitting UEs may each use a same cyclic shift for the modified sidelink reference signal. In such a scenario, the transmitted signal may be amplified by diversity gain. In some examples, the data of the single TB transmitted may be obtained from a source UE (e.g., the master wireless communications device or another wireless communications device) in a first hop relaying in sidelink. In some examples, all transmitting UEs transmitting the same TB may use the same ports or different ports. In some examples, all transmitting UEs may use the same comb offset and the same cyclic shift. During beam training, each UE may be assigned the same CS to train in an SFN manner. In some examples, transmitting UEs may use different resources, cyclic shifts, ports, comb offsets, etc. to transmit the same TB, as described previously with reference to FIG. 5.

At block 1020, the transmitting UEs receive a beam training report from the receiving UE. In some examples, as explained with reference to FIG. 8 previously, the receiving UE may generate one or more beam training reports based on a beam training procedure performed by the receiving UE and/or all participating transmitting UEs. In the example shown in FIG. 10, at block 1020, each transmitting UE may receive the same beam training report. In some examples, the transmitting UEs may receiving unique beam training reports specific to each transmitting UE.

At block 1025, each transmitting UE selects a beam based on the received beam training report. As described with reference to FIG. 8, each UE may select the beam corresponding to the highest signal quality (e.g., RSRP) or may select a beam according to any other factors or characteristics. At block 1025, each transmitting UE may select a beam corresponding to a joint or coherent transmission to facilitate the transmission of the same TB coherently to the receiving UE.

At block 1030, the one or more transmitting UEs coherently transmit a same TB. At block 1030, the transmitting UEs may transmit the same TB according to the selected beams described with reference to block 1025. In this way, the UEs may jointly transmit to the receiving UE. The receiving UE may, therefore, not differentiate between which aspects or portions of the received signals originate from which transmitting UEs. However, the receiving UE may observe a higher signal quality and/or amplitude due to diversity gain resulting from coherent transmission.

Referring now to block 1035, the method 1000 proceeds to the block 1035 if at block 1005, it is determined that a joint TB or different TBs are to be transmitted by the transmitting UEs to the receiving UE. In either case, block 1035 is next implemented. At block 1035, the method 1000 includes communicating different reference signal parameters to a plurality of transmitting UEs. In some examples, communicating different reference signal parameters may include the participating UEs transmitting or receiving different reference signal parameters depending on which UE is designated as a master UE.

As described with reference to block 1010, whether a UE transmits or receives the reference signal parameter at block 1035 depends on the role of the UE. For example, if one of the UEs is designated as the master wireless communications device, that UE would determine and transmit the reference signal parameter to the other participating UEs. If a UE is not the master wireless communications device, at block 1010, that UE may receive the reference signal parameter.

Because a joint TB or different TBs are to be transmitted by the transmitting UEs, the reference signal parameter may be different for each transmitting UE. For example, a reference signal parameter sent to one transmitting UE may specify a cyclic shift that is different from the cyclic shift associated with the reference signal of each of the other transmitting UEs. Other parameters may include any of those described herein.

At block 1040, the one or more transmitting UEs transmit one or more modified sidelink reference signals. Because the transmitting UEs are being trained to transmit a joint TB or different TBs, at block 1040, the transmission of modified sidelink reference signals may not be coherent. Aspects of the block 1040 may be similar to those described with reference to block 910 of the method 900.

In the example in which transmitting UEs are trained to transmit a different TB, one transmitting UE may use at least one of a different cyclic shift or different comb offset for the modified sidelink reference signal as used by the other transmitting UEs.

In an example in which different TBs are transmitted to an Rx-UE, joint beam training may allow each transmitting UE to determine the optimized beam to maximize performance and reduce interference. In some examples, the master wireless communications device can send SL-RS information (e.g., time-frequency resources, CS, comb offsets, report configurations, etc.) to transmitting UEs. The transmitting UEs may then use different (e.g., orthogonal) resources to beam train and transmit data. In some examples, the master wireless communications device can send indices for the different SL-RS resources, configurations such as CS, comb-offsets, ports, etc., or other instructions to be used by Tx-UEs. The transmitting UEs may use the same ports, same comb offset, and same resources with different cyclic shifts to transmit different TBs.

In some aspects, multiple transmitting UEs may transmit a joint TB. In some aspects, data transmitted by one transmitting UE may include a first portion of a joint transport block. A second portion of the joint transport block may be transmitted by at least one other transmitting UE. A joint TB transmission by multiple transmitting UEs may include determining a number of layers and CWs are determined based on a distributed MIMO structure. For example, different layers of a joint TB may be transmitted by different UEs.

At block 1045, a transmitting UE receives a beam training report. In some examples, as explained with reference to FIG. 8 previously, the receiving UE may generate one or more beam training reports based on a beam training procedure performed by the receiving UE and/or all participating transmitting UEs. In the example shown in FIG. 10, at block 1045, each transmitting UE may receive a different beam training report.

At block 1050, the transmitting UE selects a beam based on the beam training report. As described with reference to FIG. 8, each UE may select the beam corresponding to the highest signal quality (e.g., RSRP) or may select a beam according to any other factors or characteristics. At block 1050, each transmitting UE may select a beam corresponding to separate transmission to facilitate the transmission of a joint TB or different TB in a non-coherent manner to the receiving UE.

After completion of block 1050, the method 1000 may proceed to the block 1055 if it was determined at block 1005 that the transmitting UEs are to transmit a joint TB. At block 1055, one or more transmitting UEs transmit a joint TB. In such a scenario, the receiving UE may be able to distinguish which signals or portions of signal originate from different transmitting UEs because the signals were sent in a noncoherent manner.

After completion of block 1050, the method 1000 proceeds to the block 1060 if it was determined at block 1005 that the transmitting UEs are to transmit different TBs. At block 1060, the one or more transmitting UEs transmit different TBs. In such a scenario, the receiving UE may be able to distinguish which signals or portions of signal originate from different transmitting UEs because the signals were sent in a noncoherent manner and because different TBs may be associated with different transmitting UEs.

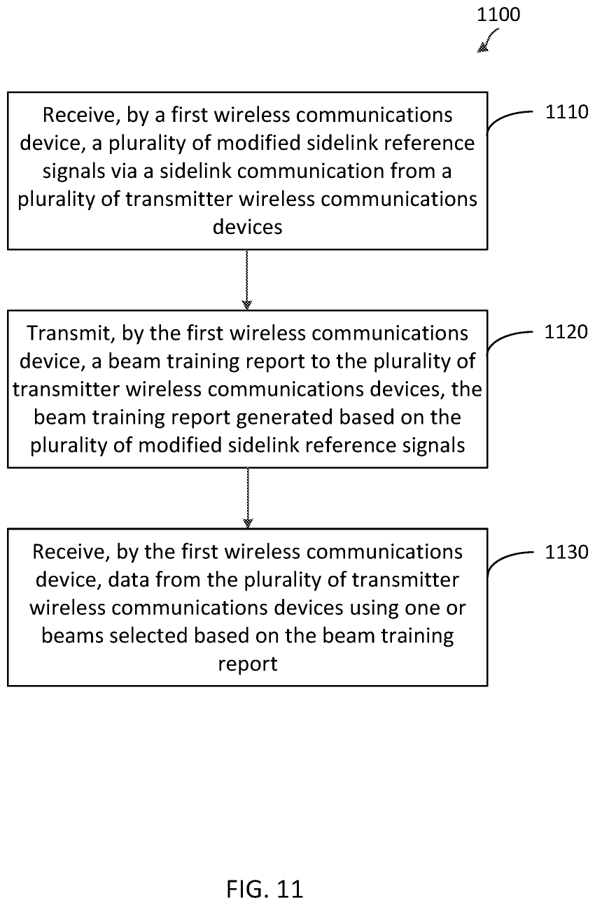

FIG. 11 is a flow diagram of a wireless communication method, according to some aspects of the present disclosure. Aspects of the method 1100 can be executed by a computing device (e.g., a processor, processing circuit, and/or other suitable component) of a wireless communications device or other suitable means for performing the aspects. For example, a wireless communications device, such as the UE 115, may utilize one or more components, such as the processor 302, the memory 304, the sidelink reference signal module 308, the transceiver 310, the modem 312, and the one or more antennas 316, to execute aspects of method 1100. The method 1100 may employ similar mechanisms as the actions described with respect to FIGS. 4-8. As illustrated, the method 1100 includes a number of enumerated aspects, but the method 1100 may include additional aspects before, after, and/or in between the enumerated aspects. In some aspects, one or more of the enumerated aspects may be omitted or performed in a different order.

At block 1110, a receiving UE receives multiple modified sidelink references signals via a sidelink communication from multiple transmitting UEs. At block 1110 of the method 1100, the modified sidelink reference signals may be multiplexed. In some aspects, multiplexing the modified sidelink reference signals may be performed by adding a cyclic shift to the modified sidelink reference signals. In some aspects, the modified sidelink reference signals may be configured based on any other parameter configurations for the transmitting UEs.

At block 1120, the receiving UE transmits a beam training report to the transmitting UEs. In some aspects, the beam training report may be generated based on the modified sidelink reference signals received by the receiving UE at block 1110. For example, the receiving UE may perform various measurements on the modified sidelink reference signals received from the multiple transmitting UEs and determine a beam for the multiple transmitting UEs, either individually or collectively, corresponding to an optimal signal quality. The beam training report described with reference to block 1120 may be based on the measurements of the receiving UE and may, in some cases, identify one or more optimal beams.

At block 1130, the receiving UE receives data from the multiple transmitting UEs. In some aspects, the transmitting UEs may transmit this data using one or beams selected based on the beam training report.

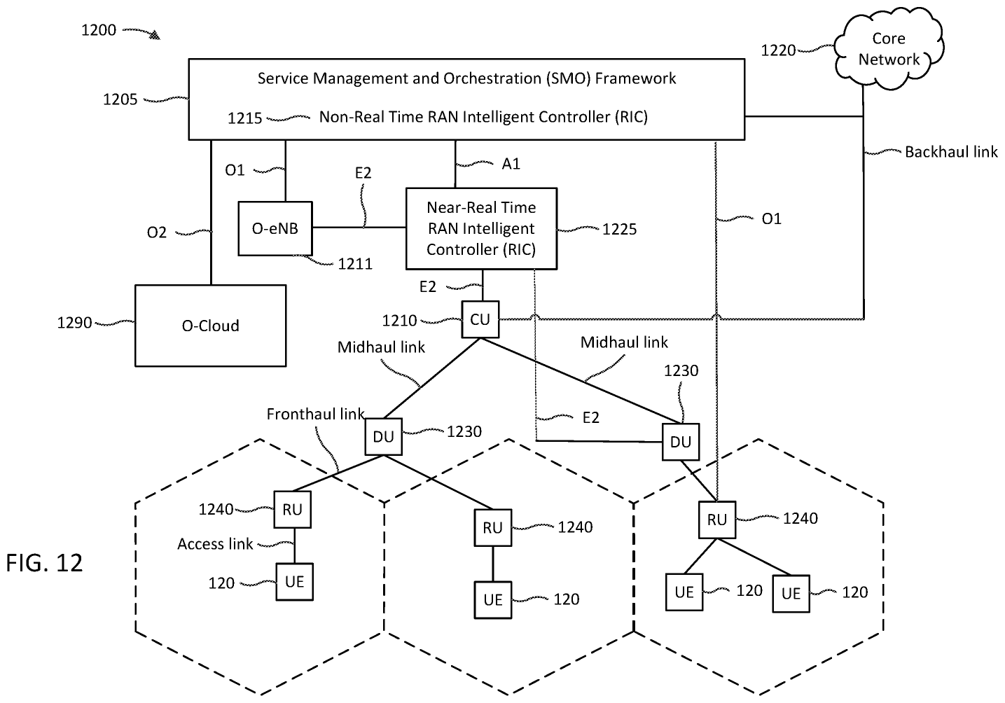

FIG. 12 shows a diagram illustrating an example disaggregated base station 1200 architecture. The disaggregated base station 1200 architecture may include one or more central units (CUs) 1210 that can communicate directly with a core network 1220 via a backhaul link, or indirectly with the core network 1220 through one or more disaggregated base station units (such as a Near-Real Time (Near-RT) RAN Intelligent Controller (RIC) 1225 via an E2 link, or a Non-Real Time (Non-RT) RIC 1215 associated with a Service Management and Orchestration (SMO) Framework 1205, or both). A CU 1210 may communicate with one or more distributed units (DUs) 1230 via respective midhaul links, such as an F1 interface. The DUs 1230 may communicate with one or more radio units (RUs) 1240 via respective fronthaul links. The RUs 1240 may communicate with respective UEs 120 via one or more radio frequency (RF) access links. In some implementations, the UE 120 may be simultaneously served by multiple RUs 1240. Aspects of the present disclosure described as occurring at, or controlled by, a BS may occur at any one or more of these different units.

Each of the units, i.e., the CUs 1210, the DUs 1230, the RUs 1240, as well as the Near-RT RICs 1225, the Non-RT RICs 1215 and the SMO Framework 1205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1210. The CU 1210 may be configured to handle user plane functionality (i.e., Central Unit-User Plane (CU-UP)), control plane functionality (i.e., Central Unit-Control Plane (CU-CP)), or a combination thereof. In some implementations, the CU 1210 can be logically split into one or more CU-UP units and one or more CU-CP units. The CU-UP unit can communicate bidirectionally with the CU-CP unit via an interface, such as the E1 interface when implemented in an O-RAN configuration. The CU 1210 can be implemented to communicate with the DU 1230, as necessary, for network control and signaling.

The DU 1230 may correspond to a logical unit that includes one or more base station functions to control the operation of one or more RUs 1240. In some aspects, the DU 1230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1230 may further host one or more low PHY layers. Each layer (or module) can be implemented with an interface configured to communicate signals with other layers (and modules) hosted by the DU 1230, or with the control functions hosted by the CU 1210.

Lower-layer functionality can be implemented by one or more RUs 1240. In some deployments, an RU 1240, controlled by a DU 1230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1240 can be implemented to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable the DU(s) 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements which may be managed via an operations and maintenance interface (such as an O1 interface). For virtualized network elements, the SMO Framework 1205 may be configured to interact with a cloud computing platform (such as an open cloud (O-Cloud) 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240 and Near-RT RICs 1225. In some implementations, the SMO Framework 1205 can communicate with a hardware aspect of a 4G RAN, such as an open eNB (O-eNB) 1211, via an O1 interface. Additionally, in some implementations, the SMO Framework 1205 can communicate directly with one or more RUs 1240 via an O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an A1 interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT RIC 1225.

In some implementations, to generate AI/ML models to be deployed in the Near-RT RIC 1225, the Non-RT RIC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via 01) or via creation of RAN management policies (such as A1 policies).

Further aspects of the present disclosure include the following:

Aspect 1 includes a method of wireless communication, comprising: transmitting, by a first wireless communications device, a sidelink reference signal via a sidelink communication to a second wireless communications device, wherein the sidelink reference signal comprises a cyclic shift and is generated based on a parameter configuration for a plurality of transmitter wireless communications devices including the first wireless communications device, the sidelink reference signal further being multiplexed with a plurality of sidelink reference signals from the plurality of transmitter wireless communications devices; receiving, by the first wireless communications device, a beam training report from the second wireless communications device based on the sidelink reference signal; and transmitting, by the first wireless communications device, data to the second wireless communications device using a beam selected based on the beam training report.

Aspect 2 includes the method of aspect 1, wherein the data comprises a same transport block to those transmitted by at least one other wireless communications device from among the plurality of transmitter wireless communications devices to the second wireless communications device, the method further comprising: using, by the first wireless communications device, a same cyclic shift for the sidelink reference signal as used by the at least one other wireless communications device.

Aspect 3 includes the method of any of aspects 1-2, wherein the data comprises a different transport block to those transmitted by at least one other wireless communications device from among the plurality of transmitter wireless communications devices to the second wireless communications device, the method further comprising: using, by the first wireless communications device, at least one of a different cyclic shift or different comb offset for the sidelink reference signal as used by the at least one other wireless communications device.

Aspect 4 includes the method of aspect 3, wherein the using further comprises: selecting, by the first wireless communications device, at least one of the different cyclic shift or the different comb offset based on at least one of an identifier associated with the first wireless communications device, or based on a random selection.

Aspect 5 includes the method of any of aspects 1-3, wherein the data comprises a first portion of a joint transport block, a second portion of the joint transport block being transmitted by at least one other wireless communications device from among the plurality of transmitter wireless communications devices to the second wireless communications device, and the transmitting the sidelink reference signal further comprises sweeping across multiple sidelink reference signals to the second wireless communications device.

Aspect 6 includes the method of any of aspects 1-3 and aspect 5, wherein the transmitting the sidelink reference signal is further based on a parameter for sidelink reference signal use determined by a master wireless communications device, the parameter comprising at least one of: an identification of one or more resources for use in beam training with the second wireless communications device; an identification of a number ports and a time/frequency allocation for the sidelink reference signal and the beam training report; or an identification of a configuration for the beam training report.

Aspect 7 includes the method of aspect 6, wherein the first wireless communications device comprises the master wireless communications device.

Aspect 8 includes the method of aspect 7, further comprising generating, by the master wireless communications device, a sidelink reference signal configuration for a reconfigurable intelligent surface (RIS) controller between the master wireless communications device and the second wireless communications device; and transmitting, by the master wireless communications device, the sidelink reference signal configuration to the RIS controller and the second wireless communications device.

Aspect 9 includes a method of wireless communication, comprising: receiving, by a first wireless communications device, a plurality of sidelink reference signals via a sidelink communication from a plurality of transmitter wireless communications devices, wherein the plurality of sidelink reference signals are multiplexed, comprise a cyclic shift, and are formed based on parameter configurations for the plurality of transmitter wireless communications devices; transmitting, by the first wireless communications device, a beam training report to the plurality of transmitter wireless communications devices, the beam training report generated based on the plurality of sidelink reference signals; and receiving, by the first wireless communications device, data from the plurality of transmitter wireless communications devices using one or more beams selected based on the beam training report.

Aspect 10 includes the method of aspect 9, wherein the data comprises a same transport block to those received by the first wireless communications device from at least one other wireless communications device from among the plurality of transmitter wireless communications devices, and wherein at least one of the plurality of sidelink reference signals corresponds to a same cyclic shift as used by the at least one other wireless communications device.

Aspect 11 includes the method of any of aspects 9-10, wherein the data comprises a different transport block to those received by the first wireless communications device from at least one other wireless communications device from among the plurality of transmitter wireless communications devices and wherein at least one of the plurality of sidelink reference signals corresponds to a different cyclic shift or different comb offset as used by the at least one other wireless communications device.

Aspect 12 includes the method of aspect 11, wherein at least one of the different cyclic shift or the different comb offset are selected by the first wireless communications device based on at least one of an identifier associated with the at least one other wireless communications device, or based on a random selection.

Aspect 13 includes the method of any of aspects 9-11, wherein: the data comprises: a first portion of a joint transport block corresponding to a first transmitter wireless communications device of the plurality of transmitter wireless communications devices; and a second portion of the joint transport block corresponding to a second transmitter wireless communications device of the plurality of transmitter wireless communications devices; and the receiving the plurality of sidelink reference signals further comprises sweeping across multiple sidelink reference signals.

Aspect 14 includes the method of any of aspects 9-11 and aspect 13, wherein the receiving the plurality of sidelink reference signals is further based on a parameter for sidelink reference signal use determined by a master wireless communications device, the parameter comprising at least one of: an identification of one or more resources for use in beam training; an identification of a number ports and a time/frequency allocation for the sidelink reference signal and the beam training report; or an identification of a configuration for the beam training report.

Aspect 15 includes the method of aspect 14, wherein the first wireless communications device comprises the master wireless communications device.

Aspect 16 includes the method of aspect 15, further comprising: generating, by the master wireless communications device, a sidelink reference signal configuration for a reconfigurable intelligent surface (RIS) controller between the master wireless communications device and the second wireless communications device; and transmitting, by the master wireless communications device, the sidelink reference signal configuration to the RIS controller and the second wireless communications device.

Aspect 17 includes a wireless communications device, comprising: a transceiver; and a processor coupled with the transceiver, wherein the wireless communications device is configured to: transmit a sidelink reference signal via a sidelink communication, wherein the sidelink reference signal comprises a cyclic shift and is generated based on a parameter configuration for a plurality of transmitter wireless communications devices including the wireless communications device, the sidelink reference signal further being multiplexed with a plurality of sidelink reference signals from the plurality of transmitter wireless communications devices; receive a beam training report based on the sidelink reference signal; and transmit data using a beam selected based on the beam training report.

Aspect 18 includes the wireless communications device of aspect 17, wherein the data comprises a same transport block to those transmitted by at least one other wireless communications device from among the plurality of transmitter wireless communications devices, the wireless communications device further configured to: use a same cyclic shift for the sidelink reference signal as used by the at least one other wireless communications device.

Aspect 19 includes the wireless communications device of any of aspects 17-18, wherein the data comprises a different transport block to those transmitted by at least one other wireless communications device from among the plurality of transmitter wireless communications devices, the wireless communications device further configured to: use at least one of a different cyclic shift or different comb offset for the sidelink reference signal as used by the at least one other wireless communications device.

Aspect 20 includes the wireless communications device of any of aspects 17-19, wherein: the data comprises a first portion of a joint transport block, a second portion of the joint transport block being transmitted by at least one other wireless communications device from among the plurality of transmitter wireless communications devices, and the transmitting the sidelink reference signal comprises sweeping across multiple sidelink reference signals.

Aspect 21 includes the wireless communications device of any of aspects 17-20, further configured to transmit the sidelink reference signal based on a parameter for sidelink reference signal use determined by a master wireless communications device, the parameter comprising at least one of: an identification of one or more resources for use in beam training; an identification of a number ports and a time/frequency allocation for the sidelink reference signal and the beam training report; or an identification of a configuration for the beam training report.

Aspect 22 includes the wireless communications device of aspect 21, wherein the wireless communications device comprises the master wireless communications device.

Aspect 23 includes the wireless communications device of aspect 22, further configured to: generate a sidelink reference signal configuration for a reconfigurable intelligent surface (RIS) controller between the wireless communications device and a second wireless communications device; and transmit the sidelink reference signal configuration to the RIS controller and the second wireless communications device.

Aspect 24 includes a wireless communications device, comprising: a transceiver, and a processor coupled with the transceiver, wherein the wireless communications device is configured to: receive a plurality of sidelink reference signals via a sidelink communication, wherein the plurality of sidelink reference signals are multiplexed, comprise a cyclic shift, and are formed based on parameter configurations for a plurality of transmitter wireless communications devices; transmit a beam training report, the beam training report based on the plurality of references signals; and receive data using one or more beams selected based on the beam training report.

Aspect 25 includes the wireless communications device of aspect 24, wherein the data comprises a same transport block to those received by the wireless communications device from at least one other wireless communications device from among the plurality of transmitter wireless communications devices, and wherein at least one of the sidelink reference signals corresponds to a same cyclic shift as used by the at least one other wireless communications device.

Aspect 26 includes the wireless communications device of any of aspects 24-25, wherein the data comprises a different transport block to those received by the wireless communications device from at least one other wireless communications device from among the plurality of transmitter wireless communications devices and wherein at least one of the sidelink reference signals corresponds to a different cyclic shift or different comb offset as used by the at least one other wireless communications device.

Aspect 27 includes the wireless communications device of any of aspects 24-26, wherein: the data comprises: a first portion of a joint transport block corresponding to a first transmitter wireless communications device of the plurality of transmitter wireless communications devices; and a second portion of the joint transport block corresponding to a second transmitter wireless communications device of the plurality of transmitter wireless communications devices; and the receiving the plurality of sidelink reference signals comprises sweeping across multiple sidelink reference signals.

Aspect 28 includes the wireless communications device of any of aspects 24-27, further configured to receive the plurality of sidelink reference signals based on a parameter for sidelink reference signal use determined by a master wireless communications device, the parameter comprising at least one of: an identification of one or more resources for use in beam training; an identification of a number ports and a time/frequency allocation for the sidelink reference signal and the beam training report; or an identification of a configuration for the beam training report.

Aspect 29 includes the wireless communications device of aspect 28, wherein the wireless communications device comprises the master wireless communications device.

Aspect 30 includes the wireless communications device of aspect 29, further configured to: generate a sidelink reference signal configuration for a reconfigurable intelligent surface (RIS) controller between the wireless communications device and a second wireless communications device; and transmit the sidelink reference signal configuration to the RIS controller and the second wireless communications device.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
transmitting, by a first wireless communications device, a sidelink reference signal via a sidelink communication to a second wireless communications device,
wherein the sidelink reference signal comprises a cyclic shift and is generated based on a parameter configuration for a plurality of transmitter wireless communications devices including the first wireless communications device, the sidelink reference signal further being multiplexed with a plurality of sidelink reference signals from the plurality of transmitter wireless communications devices;
receiving, by the first wireless communications device, a beam training report from the second wireless communications device based on the sidelink reference signal; and
transmitting, by the first wireless communications device, data to the second wireless communications device using a beam selected based on the beam training report.

2. The method of claim 1, wherein the data comprises a same transport block to those transmitted by at least one other wireless communications device from among the plurality of transmitter wireless communications devices to the second wireless communications device, the method further comprising:
using, by the first wireless communications device, a same cyclic shift for the sidelink reference signal as used by the at least one other wireless communications device.

3. The method of claim 1, wherein the data comprises a different transport block to those transmitted by at least one other wireless communications device from among the plurality of transmitter wireless communications devices to the second wireless communications device, the method further comprising:
using, by the first wireless communications device, at least one of a different cyclic shift or different comb offset for the sidelink reference signal as used by the at least one other wireless communications device.

4. The method of claim 3, wherein the using further comprises:
selecting, by the first wireless communications device, at least one of the different cyclic shift or the different comb offset based on at least one of an identifier associated with the first wireless communications device, or based on a random selection.

5. The method of claim 1, wherein:
the data comprises a first portion of a joint transport block, a second portion of the joint transport block being transmitted by at least one other wireless communications device from among the plurality of transmitter wireless communications devices to the second wireless communications device, and
the transmitting the sidelink reference signal further comprises sweeping across multiple sidelink reference signals to the second wireless communications device.

6. The method of claim 1, wherein the transmitting the sidelink reference signal is further based on a parameter for sidelink reference signal use determined by a master wireless communications device, the parameter comprising at least one of:
an identification of one or more resources for use in beam training with the second wireless communications device;
an identification of a number ports and a time/frequency allocation for the sidelink reference signal and the beam training report; or
an identification of a configuration for the beam training report.

7. The method of claim 6, wherein the first wireless communications device comprises the master wireless communications device.

8. The method of claim 7, further comprising:
generating, by the master wireless communications device, a sidelink reference signal configuration for a reconfigurable intelligent surface (RIS) controller between the master wireless communications device and the second wireless communications device; and
transmitting, by the master wireless communications device, the sidelink reference signal configuration to the RIS controller and the second wireless communications device.

9. A method of wireless communication, comprising:
receiving, by a first wireless communications device, a plurality of sidelink reference signals via a sidelink communication from a plurality of transmitter wireless communications devices,
wherein the plurality of sidelink reference signals are multiplexed, comprise a cyclic shift, and are formed based on parameter configurations for the plurality of transmitter wireless communications devices;
transmitting, by the first wireless communications device, a beam training report to the plurality of transmitter wireless communications devices, the beam training report generated based on the plurality of sidelink reference signals; and
receiving, by the first wireless communications device, data from the plurality of transmitter wireless communications devices using one or more beams selected based on the beam training report.

10. The method of claim 9, wherein the data comprises a same transport block to those received by the first wireless communications device from at least one other wireless communications device from among the plurality of transmitter wireless communications devices, and wherein at least one of the plurality of sidelink reference signals corresponds to a same cyclic shift as used by the at least one other wireless communications device.

11. The method of claim 9, wherein the data comprises a different transport block to those received by the first wireless communications device from at least one other wireless communications device from among the plurality of transmitter wireless communications devices and wherein at least one of the plurality of sidelink reference signals corresponds to a different cyclic shift or different comb offset as used by the at least one other wireless communications device.

12. The method of claim 11, wherein at least one of the different cyclic shift or the different comb offset are selected by the first wireless communications device based on at least one of an identifier associated with the at least one other wireless communications device, or based on a random selection.

13. The method of claim 9, wherein:
the data comprises:
a first portion of a joint transport block corresponding to a first transmitter wireless communications device of the plurality of transmitter wireless communications devices; and
a second portion of the joint transport block corresponding to a second transmitter wireless communications device of the plurality of transmitter wireless communications devices; and
the receiving the plurality of sidelink reference signals further comprises sweeping across multiple sidelink reference signals.

14. The method of claim 9, wherein the receiving the plurality of sidelink reference signals is further based on a parameter for sidelink reference signal use determined by a master wireless communications device, the parameter comprising at least one of:
an identification of one or more resources for use in beam training;
an identification of a number ports and a time/frequency allocation for the sidelink reference signal and the beam training report; or
an identification of a configuration for the beam training report.

15. The method of claim 14, wherein the first wireless communications device comprises the master wireless communications device.

16. The method of claim 15, further comprising:
generating, by the master wireless communications device, a sidelink reference signal configuration for a reconfigurable intelligent surface (RIS) controller between the master wireless communications device and the second wireless communications device; and
transmitting, by the master wireless communications device, the sidelink reference signal configuration to the RIS controller and the second wireless communications device.

17. A wireless communications device, comprising:
a transceiver; and
a processor coupled with the transceiver, wherein the wireless communications device is configured to:
transmit a sidelink reference signal via a sidelink communication,
wherein the sidelink reference signal comprises a cyclic shift and is generated based on a parameter configuration for a plurality of transmitter wireless communications devices including the wireless communications device, the sidelink reference signal further being multiplexed with a plurality of sidelink reference signals from the plurality of transmitter wireless communications devices;
receive a beam training report based on the sidelink reference signal; and
transmit data using a beam selected based on the beam training report.

18. The wireless communications device of claim 17, wherein the data comprises a same transport block to those transmitted by at least one other wireless communications device from among the plurality of transmitter wireless communications devices, the wireless communications device further configured to:
use a same cyclic shift for the sidelink reference signal as used by the at least one other wireless communications device.

19. The wireless communications device of claim 17, wherein the data comprises a different transport block to those transmitted by at least one other wireless communications device from among the plurality of transmitter wireless communications devices, the wireless communications device further configured to:
use at least one of a different cyclic shift or different comb offset for the sidelink reference signal as used by the at least one other wireless communications device.

20. The wireless communications device of claim 17, wherein:
the data comprises a first portion of a joint transport block, a second portion of the joint transport block being transmitted by at least one other wireless communications device from among the plurality of transmitter wireless communications devices, and
the transmitting the sidelink reference signal comprises sweeping across multiple sidelink reference signals.

21. The wireless communications device of claim 17, further configured to transmit the sidelink reference signal based on a parameter for sidelink reference signal use determined by a master wireless communications device, the parameter comprising at least one of:
an identification of one or more resources for use in beam training;
an identification of a number ports and a time/frequency allocation for the sidelink reference signal and the beam training report; or
an identification of a configuration for the beam training report.

22. The wireless communications device of claim 21, wherein the wireless communications device comprises the master wireless communications device.

23. The wireless communications device of claim 22, further configured to:
generate a sidelink reference signal configuration for a reconfigurable intelligent surface (RIS) controller between the wireless communications device and a second wireless communications device; and
transmit the sidelink reference signal configuration to the RIS controller and the second wireless communications device.

24. A wireless communications device, comprising:
a transceiver, and
a processor coupled with the transceiver, wherein the wireless communications device is configured to:
receive a plurality of sidelink reference signals via a sidelink communication,
wherein the plurality of sidelink reference signals are multiplexed, comprise a cyclic shift, and are formed based on parameter configurations for a plurality of transmitter wireless communications devices;
transmit a beam training report, the beam training report based on the plurality of references signals; and
receive data using one or more beams selected based on the beam training report.

25. The wireless communications device of claim 24, wherein the data comprises a same transport block to those received by the wireless communications device from at least one other wireless communications device from among the plurality of transmitter wireless communications devices, and wherein at least one of the sidelink reference signals corresponds to a same cyclic shift as used by the at least one other wireless communications device.

26. The wireless communications device of claim 24, wherein the data comprises a different transport block to those received by the wireless communications device from at least one other wireless communications device from among the plurality of transmitter wireless communications devices and wherein at least one of the sidelink reference signals corresponds to a different cyclic shift or different comb offset as used by the at least one other wireless communications device.

27. The wireless communications device of claim 24, wherein:
the data comprises:
a first portion of a joint transport block corresponding to a first transmitter wireless communications device of the plurality of transmitter wireless communications devices; and
a second portion of the joint transport block corresponding to a second transmitter wireless communications device of the plurality of transmitter wireless communications devices; and
the receiving the plurality of sidelink reference signals comprises sweeping across multiple sidelink reference signals.

28. The wireless communications device of claim 24, further configured to receive the plurality of sidelink reference signals based on a parameter for sidelink reference signal use determined by a master wireless communications device, the parameter comprising at least one of:
an identification of one or more resources for use in beam training;
an identification of a number ports and a time/frequency allocation for the sidelink reference signal and the beam training report; or
an identification of a configuration for the beam training report.

29. The wireless communications device of claim 28, wherein the wireless communications device comprises the master wireless communications device.

30. The wireless communications device of claim 29, further configured to:
generate a sidelink reference signal configuration for a reconfigurable intelligent surface (RIS) controller between the wireless communications device and a second wireless communications device; and
transmit the sidelink reference signal configuration to the RIS controller and the second wireless communications device.
